(19) United States
(12) Patent Application Publication
(10) Pub. No.: US 2026/0127538 A1
(43) Pub. Date: May 7, 2026

(54) SYSTEM AND METHODS FOR GOVERNED AGENTIC AI PLATFORM WITH PREDICTION-EVENT LINEAGE AND DIGITAL-TWIN SIMULATION

(71) Applicants: David Nason, Durham, NC (US); Kirankumar Balijepalli, Sammamish, WA (US); Grant Kaley, Morrisville, NC (US); Jeff Godwin, Raleigh, NC (US); Aaron Kyle Pickrell, Cary, NC (US)

(72) Inventors: David Nason, Durham, NC (US); Kirankumar Balijepalli, Sammamish, WA (US); Grant Kaley, Morrisville, NC (US); Jeff Godwin, Raleigh, NC (US); Aaron Kyle Pickrell, Cary, NC (US)

(21) Appl. No.: 19/382,498

(22) Filed: Nov. 7, 2025

Related U.S. Application Data
(60) Provisional application No. 63/717,661, filed on Nov. 7, 2024.

(51) Int. Cl. G06Q 10/067; G06Q 10/08

(52) U.S. Cl. CPC G06Q 10/0674; G06Q 10/08

(57) ABSTRACT

A management system is provided having a digital twin layer, data integration layer, artificial intelligence (AI) and cognitive processing layer, and an extensibility and customization layer, operatively coupled with processing circuitry and memory. The system generates a virtual representation of a network with hubs and endpoints connected electronically, simulates the impact of external factors, and collects and processes real-time data from multiple sources to continuously update simulations. Machine learning algorithms are applied to generate predictive models, enabling users to adjust parameters and test alternative supply chain configurations. The system evaluates the impact of these configurations on performance metrics and provides optimization recommendations, enhancing decision-making and operational efficiency in supply chain networks.

### RELATED APPLICATIONS

This application claims priority to and the benefit of U.S. Provisional Patent Application No. 63/717,661, filed Nov. 7, 2024, which is incorporated herein by reference in its entirety.

### FIELD OF THE INVENTION

This disclosure relates to enterprise decision-intelligence platforms, and more particularly to governed, explainable Artificial Intelligence (AI) systems that harmonize multi-source operational data, generate prediction events, simulate system state via digital twins, and orchestrate financial-guardrailed actions across healthcare and supply-chain logistics environments in a governed, closed-loop control plane.

### BACKGROUND

Supply chain systems are typically fragmented across Enterprise Resource Planning (ERP), Electronic Health Records (EHR), Warehouse Management Systems (WMS), Transportation Management Systems (TMS), scheduling, and finance systems, that produce siloed data ans uncoordinated workflows, causing decision latency and blind spots. Existing tools optimize narrow functions but fail to orchestrate the stack end-to-end; legacy architectures accreted from bolt-ons create tangled workflows that resist real-time decisions, simulations, and integrated responses. Supply chains are complex networks involving multiple stakeholders, and are susceptible to disruptions caused by external factors, such as weather, traffic, geopolitical events, supply shortages, and natural disasters. Traditional supply chain management systems often rely on static dashboards and legacy business intelligence (BI) tools that fail to meet the real-time demands of modern data-driven businesses. These tools lack the ability to visualize and simulate potential impacts and provide actionable insights in an intuitive, user-friendly environment, and they often require technical expertise for querying and analyzing data. As a result, they do not provide a comprehensive, integrated environment for strategic planning and decision-making.

Over the years, the technology architectures underpinning these systems have evolved haphazardly. AI tools are often introduced ad hoc, without unified governance, explainability, or cost/latency guardrails, resulting in inconsistent outcomes, opaque decision paths, and regulatory risk. Moreover, simulation capabilities—where present—rarely align with real-time data semantics, limiting their value for “what-if” decisioning and change-impact analysis. Rather than starting from a cohesive, future-proof foundation, organizations have added layer upon layer of bolt-on systems and disconnected modules to address immediate needs. Over time, this approach has often created a fragmented patchwork architecture, where different systems, standards, and workflows are tangled together, making it difficult to scale, integrate, or extract real-time insights. This has led to significant operational inefficiencies, limiting businesses' ability to respond swiftly to disruptions and shifts in the market.

Healthcare and supply-chain logistics share hard operational constraints, auditability requirements, and strict safety/cost envelopes. Conventional platforms lack: (i) a stable event model that separates facts from predictions; (ii) a governed control plane that applies policy, privacy, provenance, and financial guardrails to model/agent invocations; (iii) a digital-twin layer that can validate AI recommendations against domain constraints; and (iv) a decision-routing layer that executes multi-system actions with traceable justification.

### SUMMARY

Comprising: (a) a data harmonization layer (DHX) that normalizes and feature-engineers multi-source operational data; (b) a governed control plane (DRX) that enforces authentication/authorization, policy, rate/cost/latency/freshness guardrails, privacy protections, and auditability for AI agents and models, with a machine learning model registry, and a retrieval-augmented knowledge layer for low-hallucination enterprise access, and role-bases/policy-based access control (RBAC/PBAC [symbol] , dual-key authentication, guardrails, and comprehensive audit; (c) a prediction event framework that emits versioned, explainable prediction events; (d) a digital-twin simulation layer (CTD) that validates and stress-tests proposed actions; (e) a financial guardrail layer (CRT) that evaluates budgetary constraints and tradeoffs; and (f) a decision-routing layer (DI) that executes approved actions through APIs, webhooks, or electronic data interchange (EDI) with end-to-end lineage.

A digital-twin sandbox (CTD) for scenario planning and policy testing, linked to Decision Routing (DRI) for role-based delivery of actions and recommendations.

Financial Guardrails (CRT) integrating treasury and liquidity constraints with operational recommendations for economically grounded decisions and actions that are financially guarded and auditable, elevating mission-control decisions into economic governance.

Prediction Events as first-class records containing uncertainty, reason codes, and lineage; events are versioned and not co-mingled with facts by default.

Privacy-by-design with in-situ prediction-time access; Health Insurance Portability and Accountability Act (HIPAA)/General Data Protection Regulation (GDPR)/System and Organization Controls 2 (SOC2)-aligned security and audit.

An Integration Layer supports connectors (ERP, WMS, TMS, CRM), multi-protocol communication (Representational State Transfer (REST), GraphQL, WebSockets, Google™ Remote Procedure Calls (gRPC), Message Queuing Telemetry Transport (MQTT), Electronic Data Interchange (EDI)), standardized Extract, Transform, and Load (ETL), event streaming (Kafka/Webhooks), and security/compliance (OAuth2/JWT, TLS 1.3, AES-256, HIPAA/GDPR/SOC2). The platform records all invocations, intermediate artifacts, and outcomes to an event/audit store, enabling root-cause analysis, replay, governance reporting, and continuous improvement of models and policies.

### BRIEF DESCRIPTION OF FIGURES

FIG. 1 shows an environment in which examples may operate.

FIG. 2 shows an application layer stack of a management system of FIG. 1.

FIG. 3 illustrates a virtual representation of a network generated using the management system of FIG. 1 and the application layer of FIG. 2.

FIG. 4 shows a method for presenting a virtual representation of a network using a variety of tools.

FIGS. 5A and 5B illustrate a dashboard generated by a digital twin layer of FIG. 2 and presented to an end user.

FIG. 6 illustrates a virtual representation of a network generated using the management system of FIG. 1 and the application layer of FIG. 2.

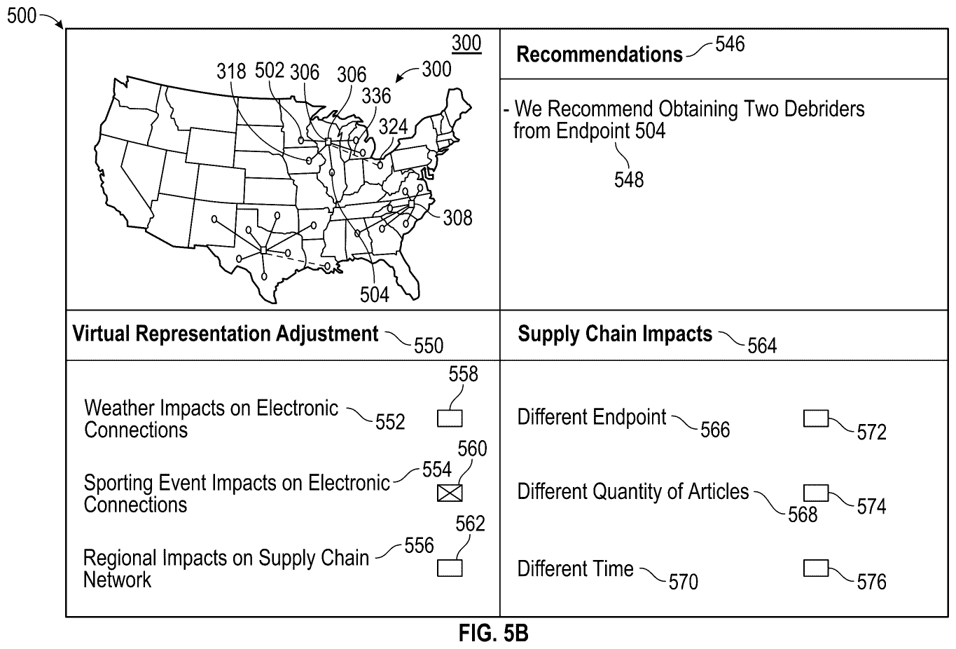

FIG. 7 shows a dashboard generated by a digital twin layer of FIG. 2 and presented to an end user.

FIG. 8 is a block diagram illustrating an example of a machine upon which one or more examples may be implemented.

FIG. 9 illustrates a device that can be used to implement exemplary examples of the present disclosure.

FIG. 10 is an architecture for a Deep-SKAI platform.

FIG. 11 illustrates a governed control plane.

FIG. 12 is a schema overview of a prediction event contract.

FIG. 13 illustrates an integration and protocol topology.

FIG. 14 shows mission control for end-to-end flow in a healthcare example.

FIG. 15 shows mission control for end-to-end flow in a supply chain example.

FIG. 16 illustrates an application stack.

FIG. 17 illustrates an application stack.

FIG. 18 illustrates a prediction event contract schema.

FIG. 19 shows an integration and protocol topology.

FIG. 20 illustrates a swim lane example of healthcare mission control implementation.

FIG. 21 illustrates a swim lane example of supply-chain logistics mission control implementation.

FIG. 22 illustrates a platform architecture.

### DETAILED DESCRIPTION

There is a need for a mission-control platform that (i) unifies multi-system signals, (ii) executes governed agents and models without bulk data movement, (iii) emits prediction events with lineage and explainability, and (iv) connects simulation and finance so the system can decide and act, not merely visualize. In today's rapidly evolving business landscape, it is not enough to rely solely on human expertise or static dashboards. Organizations need dynamic, real-life representations of their operations that blend human intelligence and artificial intelligence (AI) to work together seamlessly. This combination would provide predictive insights and enable real-time, automated decision-making—something traditional systems have failed to achieve.

These challenges persist across industries. Inadequate integration, disjointed workflows, and the lack of real-time, actionable insights continue to undermine operational efficiency and resilience. Supply chain managers and decision-makers are often left without the tools they need to anticipate disruptions, optimize operations, or develop strategic responses in real time.

Examples address these issues by offering a next-generation platform designed with these modern challenges in mind. The platform provides a centralized, mission control environment for managing and optimizing supply chain operations. By combining Generative AI (GenAI)-powered natural language interactions, digital twin simulations, real-time data analytics, and AI-driven decision-making tools, the management system described herein enables organizations to create a virtual replica of their entire supply chain network. This virtual replica, or digital twin, allows users to simulate various scenarios, predict disruptions, and develop strategic responses, significantly improving the agility and resilience of their supply chains. the management system described herein provides a comprehensive, user-centered platform that democratizes access to actionable insights, allowing both technical and non-technical users to make informed decisions in real time.

Moreover, examples provide a management system that graphically presents a supply-chain network using a variety of tools. These tools include a digital twin layer, a data integration layer, an extensibility and customization layer, and an artificial intelligence (AI) and cognitive processing layer. The management system also includes a natural language interaction interface.

The digital twin layer creates a continuously-updated virtual representation of a supply chain network in an entirety of the supply chain network. The supply chain network includes a hub and endpoints associated with the hub. The hub can represent a distribution center and the endpoints can represent vendors who provide articles to the distribution center. The virtual representation also shows electronic connections between the hub and the endpoints and between the endpoints. The electronic connections can represent transportation routes between the endpoints and the hub and between ones of the endpoints, such as a transportation route between a first endpoint and a second endpoint. The digital twin simulation module can also simulate an impact of an external factor on the hub, one of the endpoints, or the electronic connections. In addition, the data integration module collects real-time data and uses this real-time data to update the simulated impact.

The management system allows a user to make changes to the supply chain network at the virtual representation to create an alternative supply chain configuration. The management system also determines how the alternative supply chain configuration impacts the supply chain network. These changes can include switching endpoints that supply articles to the hub, moving the hub to a different location, changing a number of articles provided by the different endpoints, and any number of other changes. The digital twin layer can adjust the virtual representation to reflect the changes to the supply chain network.

In order to continuously update the virtual representation, a data integration layer collects real time data from multiple sources. The management system then processes the real-time data. Using the processed data, the management system continuously updates the impact simulated by the digital twin simulation module.

The management system can be a supply-chain mission control platform that provides a comprehensive mission control environment to enhance decision-making and optimize supply chain operations. In addition to a digital twin layer, the management system integrates advanced technologies such as Generative AI (GenAI), real-time data analytics, predictive modeling, natural language interaction, and AI-augmented decision-making. These features collectively allow organizations to enhance the efficiency and resilience of their supply chains by offering real-time insights, simulations, and automated recommendations.

The management system described herein constitutes a technological solution that goes well beyond abstract ideas and provides concrete technical improvements to computer systems and supply chain management technology. The management system described herein is fundamentally a technical system that integrates multiple complex software components and hardware systems to solve specific technological problems in supply chain data processing and analysis. The management system described herein comprises a plurality of distinct technical layers, including a Real-Time Data Integration System that collects and processes data from Internet of Things (IoT) sensors, Global Positioning System (GPS) trackers, ERP systems, WMS, and TMS systems. This represents a concrete technical implementation rather than an abstract idea, as the management system described herein requires specific technical solutions for data ingestion, processing, cleaning, and real-time analysis across disparate enterprise systems.

The AI and cognitive processing layer of the management system described herein uses machine learning algorithms to perform automated Structured Query Language (SQL) generation, predictive modeling, and contextual recommendations. This technical implementation goes beyond merely automating known business processes—it provides a technological solution for handling complex, multi-source data analysis that cannot be performed manually or through conventional business intelligence tools.

The management system described herein addresses specific technological problems that arise in modern supply chain systems, particularly the technical challenges of integrating fragmented, incompatible enterprise systems that have evolved haphazardly and created a fragmented patchwork architecture. The virtual representation software/hardware of the management system described herein specifically solves the technological problem of enabling real-time data exchange between disparate systems including ERP, CRM, TMS, WMS, EDI, and IoT systems.

The management system described herein provides a technical solution for real-time simulation based on external data factors including weather, traffic, and geopolitical events. This involves sophisticated mathematical modeling using deterministic and stochastic modeling and complex probability calculations that incorporate weighted factors and multiple variables. This represents a concrete technical improvement over existing static dashboard systems that lack real-time simulation capabilities.

The management system described herein includes detailed technical implementation through its multi-layered architecture. The data processing layer performs real-time anomaly detection by comparing incoming data streams against historical patterns and established thresholds. The AI and cognitive processing layer creates agents on the fly that are spun up to perform specific analytical tasks based on detected anomalies and various scenarios.

The natural language interaction implements advanced natural language processing that goes beyond simple key-value pair matching to provide conversational level interaction where the management system described herein can understand context and intent. This technical implementation allows users to make contextual references like draw that line in white where the system understands that line based on the current operational context. The management system described herein technical implementation extends to integration with physical systems and sensors, demonstrating concrete technological application.

The system produces concrete, measurable results in the physical world through its optimization recommendations. For example, the AI and cognitive processing layer can recommend specific alternative transportation routes, supplier changes, and inventory adjustments that result in quantifiable cost savings and risk reduction. These represent concrete technological improvements to supply chain operations rather than abstract business concepts.

The management system described herein transcends conventional business methods by providing technological solutions that require specific computer implementation. The system's ability to process real-time data from multiple enterprise systems, perform complex predictive modeling, and generate dynamic scenario simulations cannot be performed mentally or with pen and paper. The technical complexity of integrating multiple AI engines, processing real-time IoT data streams, and performing automated decision-making requires sophisticated computer systems and algorithms.

The management system described herein demonstrates technical implementation by embedding analytical insights directly into existing workflow systems like direct messaging applications and email. This technical integration capability represents a concrete improvement to how computer systems interact and share processed information, going beyond abstract collaboration concepts to provide specific technological solutions.

These technical aspects collectively demonstrate that the management system described herein provide concrete technological solutions to specific technical problems in enterprise system integration, real-time data processing, and automated decision-making systems.

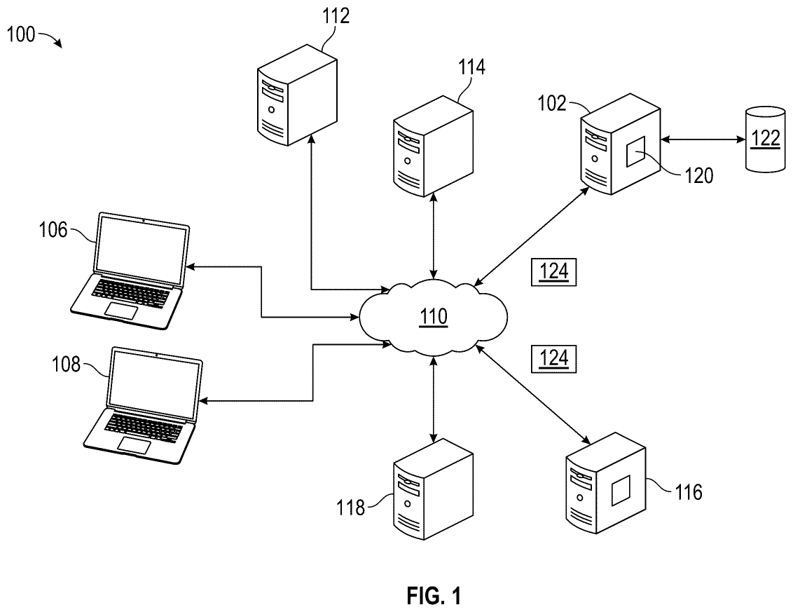

Now making reference to FIG. 1, a network environment 100 is shown in which examples can operate. The network environment 100 can include a management system 102 that can be a computing device having hardware and software functionality to perform the features discussed herein. For example, the management system 102 can have a platform architecture that performs the functions described herein. The network environment 100 can also include devices 106 and 108 that can be computing devices having hardware and software functionality to perform the features discussed herein. The network environment 100 can also include a network 110 that can facilitate communication between the management system 102, the devices 106 and 108, and source devices 112-118. The source devices 112-118 can be associated with sources that can provide real-time data to the management system 102. The source devices 112-118 can be computing devices having hardware and software functionality to perform the features discussed herein.

The network 110 can be any network that enables communication between or among machines, databases, and devices (e.g., the management system 102, the devices 106 and 108, and the source devices 112-118). The network 110 can be a wired network, a wireless network (e.g., a mobile or cellular network), or any suitable combination thereof. The network 110 can include one or more portions that constitute a private network, a public network (e.g., the Internet), or any suitable combination thereof. Accordingly, the network 110 can include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 110 can communicate information via a transmission medium. As used herein, “transmission medium” shall be taken to include any intangible medium that is capable of storing, encoding, or carrying instructions for execution by a machine, and includes digital or analog communication signals or other intangible media to facilitate communication of such software.

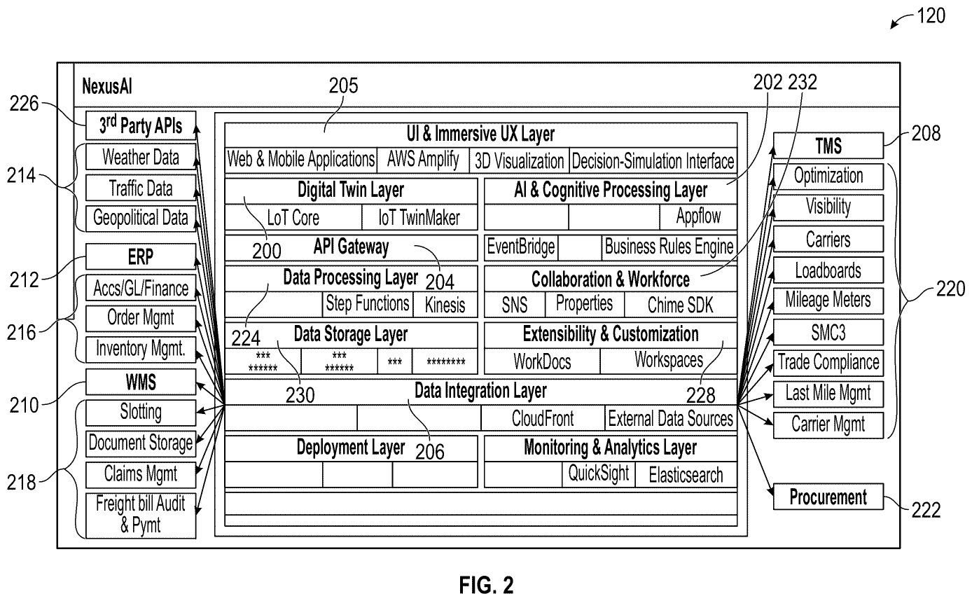

The management system 102 can also include virtual representation software/hardware 120 that can operate with a digital twin layer 200 (FIG. 2) ti to generate virtual representations, as will be discussed further on. The virtual representation hardware/software 120 includes core hardware, such as processors, graphics cards, random access memory (RAM) to generate virtual representations.

The virtual representation hardware/software 120, also includes engines, such as Unity and Unreal engine, that can be used to generate virtual representations.

Moreover, the virtual representation hardware/software 120 includes simulation platforms, such as NVIDIA Omniverse, Ansys, and Siemens Teamcenter X to provide tools for building real-time digital twins and conducting complex engineering simulations. The virtual representation hardware/software 120 also has virtualization tools along with augmented reality and virtual reality authoring software. When reference is made to the management system 102 performing functions described herein, the virtual representation hardware/software 120 can also be performing the described functions. Thus, the virtual representation hardware/software can have the features and functionality described herein.

Moreover, the management system 102 has a database 122. The database can be external to the management system 102 or internal to the management system 102. The database 122 can be a data storage resource and may store data structured as a text file, a table, a spreadsheet, a relational database (e.g., an object-relational database), a triple store, a hierarchical data store, or any suitable combination thereof.

As noted above, examples relate to systems, such as the management system 102, and methods that provide a management system that graphically presents a supply-chain network using a variety of tools. In order to provide this functionality, the virtual representation software/hardware 120 includes various application layers, as shown with reference to FIG. 2.

FIG. 2 is a consolidated overall platform architecture diagram depicting end-to-end data and control paths across both embodiments, including sources (enterprise systems and external signals), the DHX layer, the governed DRX control plane (gateway, orchestrator, machine learning model,/owledge/ Retrieval-Augmented Generation (RAG), events/observability), mid-tier CRT/CTD/DI services, standardized interfaces (APIs/webhooks/event sinks), and consumer applications, with representative directional flows between layers.

Virtual representation software/hardware 120 has a digital twin layer 200 that is a multi-functional component that operates at three distinct technical levels within the management system 102. One function of the digital twin layer 200 includes a visualization and display mechanism where the digital twin layer 200 functions as a graphical representation interface that displays all events identified by a cognitive processing layer 202.

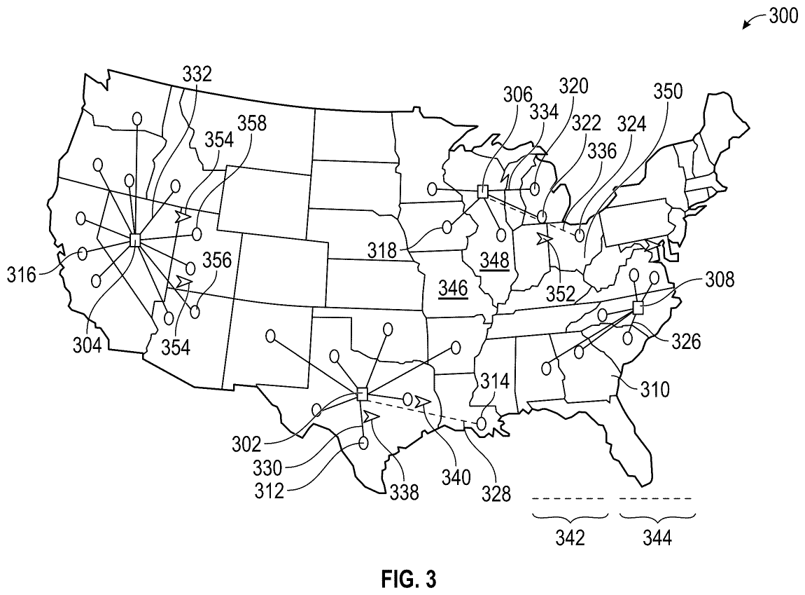

The digital twin layer 200 functions to generate a virtual representation 300 (FIG. 3) of a network, which can be a virtual representation of a supply chain network, that includes hubs 302-308 and endpoints 310-324 associated with the hubs 302-308 via electronic connections 326-336. Throughout, reference will be made to the hubs 302-308 and to one of the hubs 302-308, such as the hub 302. Reference and description herein to one of the hubs 302-308, such as the hub 302, is applicable to the remaining hubs 302-308, such as the hubs 304-308 when the hub 302 is described. Likewise, throughout, reference will be made to the endpoints 310-324 and to one of the endpoints 310-324, such as the endpoint 310. Reference and description herein to one of the endpoints 310-324, such as the endpoint 310, is applicable to the remaining endpoints 310-324, such as the endpoints 312-324 when the endpoint 310 is described. Similarly, throughout, reference will be made to the electronic connections 326-336 and to one of the electronic connections 326-336, such as the electronic connection 326. Reference and description herein to one of the electronic connections 326-336, such as the electronic connection 326, is applicable to the remaining electronic connections 326-336, such as the electronic connections 328-336 when the electronic connection 326 is described.

The digital twin layer 200 functions as a user interface mechanism that presents a state of a supply chain to end users through visual representations such as the virtual representation 300. The virtual representation 300 shows pathways, such as roadways, flight paths, and sea lanes, as electronic connections 326-336 between the hubs 302-308 and the end points 310-324. The digital twin layer 200 also overlays weather events and other real-time events over the virtual representation 300.

The hubs 304-308 can represent a centralized location to which articles, such as articles 338 and 340, are sent. The centralized location can also send the articles 338 and 340 to end users. Examples can include a distribution center where articles from different endpoints, such as vendors or suppliers, are sent to the distribution center and the distribution center then ships the articles to end users. The hubs 304-308 can also be a centralized location for an entity, such as the headquarters for the entity, and the endpoints 310-324 can be satellite locations associated with the centralized locations. When the hubs 304-308 are centralized locations, the endpoints 310-324 can also be end users who receive services from the centralized location. The hubs 304-308 can also be a combination of the examples described herein, such as a distribution center in one instance and a headquarters in another instance. When the hubs 302-308 are centralized headquarters, the endpoints 310-324 can be distribution centers.

The electronic connections can represent pathways between the hubs 304-308 and the endpoints 310-324. For example, the electronic connections 326-336 can represent roadways, railways, air routes, and water routes between the hubs 302-308 and the endpoints 310-324.

The digital twin layer 200 also provides status indicators 342 and 344 on the virtual representation 300. The status indicators 342 and 344 can serve to differentiate between elements of the virtual representation 300 functioning normally versus those experiencing problems. For example, the status indicator 342 can correspond to the electronic connection 328, where the end point 314 can correspond to a location in Louisiana. A hurricane may be approaching Louisiana and the time associated with traversing the roadway associated with the electronic connection 328 will take longer due to the hurricane.

As a further example, the status indicator 344 can correspond to the electronic connection 336. Lake effect snow may be forecast, which will affect Ohio, where the end point 324 is located. The time associated with traversing the roadway associated with the electronic connection 336 will take longer due to the lake effect snow. The status indicator 344 can indicate this abnormal condition.

Returning to FIG. 2, the digital twin layer 200 provides edit capabilities where users drag and drop items on the virtual representation 300 for scenario testing. This functionality allows users to determine “what-if” scenario analysis by rebuilding the supply chain network represented by the virtual representation 300 based on user modifications. This functionality imparted by the digital twin layer 200 creates a sandbox environment where users can simulate changes and observe the effects of the changes on the supply chain network and the virtual representation 300. This technical implementation allows users to manipulate variables and see predictive outcomes through the integrated modeling engine.

The digital twin layer 200 represents an internal data model that stores information for the supply chain network of the virtual representation 300. This includes dimensional descriptions, characteristics, and status of supply chain elements, such as the hubs 302-308, the endpoints 310-324, and the electronic connections 326-336, which are stored as database values that can be read out to create an understanding of a current state of the supply chain network of the virtual representation 300. As will be discussed further on, the management system 102 continuously updates based on real-time data from sources such as Internet of Things (IoT) sensors, global positioning system (GPS) trackers, enterprise resource planning (ERP) systems, and external sources like weather forecasts. The management system 102 can use the real-time data to create the virtual representation 300 of a supply chain network that mirrors real-world assets including suppliers, warehouses, distribution centers, transportation routes, and product flows. The technical architecture of the management system 102 enables simulation of external factors such as natural disasters, geopolitical events, weather conditions, and transportation delays through the application of integrated predictive modeling algorithms on the supply chain network of the virtual representation 300.

The digital twin layer 200 can directly connect with an AI and cognitive processing layer 202 through an Application Programming Interface (API) gateway 204. The AI and cognitive processing layer 202 can determine when an abnormality, such as a problem, exists at one of the hubs 302-308, one of the endpoints 310-324, and/or one of the electronic connections 326-336. The AI and cognitive processing layer 202 functions as a central intelligence engine that transforms raw data into actionable insights and automated responses. The AI and cognitive processing layer 202 collects all processed data from a data integration layer 206, analyzes identified anomalies that have been flagged by lower-level systems, and dynamically creates specialized agents on the fly to address specific situations based on findings made by the AI and cognitive processing layer 202.

Location-specific incidents represent a category of external disruptions that can impact a supply chain network as represented by the virtual representation 300 at the hubs 302-308, the endpoints 310-324, and the electronic connections 326-336. The incidents encompass a broad range of localized events including strikes that affect production or transportation, accidents that impact supply chain operations, and other location-specific events that disrupt operations at any of the hubs 302-308, the endpoints 310-324, and the electronic connections 326-336. The management system 102 accounts for these types of incidents as external factors that can create cascading effects throughout the supply chain network as represented by the virtual representation 300. Location-specific incidents are characterized by their concentrated geographic impact, often affecting particular facilities, transportation hubs, or critical nodes within the supply chain infrastructure.

The digital twin layer 200 enables end users to model and predict the impact of location-specific incidents on their overall supply chain performance and develop targeted mitigation strategies. The management system 200 can simulate scenarios involving strikes, accidents, and other location-specific disruptions to help end users, such as supply chain managers, understand potential ripple effects and evaluate response options before incidents occur. This predictive capability allows organizations to develop contingency plans, identify alternative suppliers or routes, and implement proactive measures to minimize the operational impact of location-specific incidents. The management system 102 scenario modeling functionality enables users to test various response strategies and select the most effective approaches for maintaining supply chain continuity when faced with these localized but potentially severe disruptions.

The AI and cognitive processing layer 202 allows different machine learning models to be customized for various data types and data sources. Different end users may employ different machine learning models. Examples of machine learning models include supervised and unsupervised learning models. Examples of supervised learning models include linear regression, logistic regression, decision trees, support vector machines (SVMs), random forest, naive bayes, and k-Nearest Neighbors (kNN). Examples of unsupervised learning models include K-means clustering, hierarchical clustering, and principal component analysis (PCA). Machine learning models can also include semi-supervised and self-supervised models, such as generative adversarial networks (GANs), reinforcement learning models, and deep learning models. Examples of reinforcement learning models include Q-learning, deep Q networks (DQNs), and policy gradient methods. Machine learning models can also be deep learning models that include convolutional neural networks (CNNs), recurrent neural networks (RNNs), long short-term memory networks (LSTMs), and transformer models.

The AI and cognitive processing layer 202 performs tasks including SQL generation, predictive modeling, scenario forecasting, and automated decision-making, while continuously learning from past outcomes to improve recommendation accuracy over time. Examples of predictive modeling that can be used include logistic regression, autoregressive integrated moving average, K-Means clustering, random forest, decision trees, time series models, outlier models, and gradient boosted models, such as XGBoost.

Past outcomes can be determined and used to train the AI and cognitive processing layer 202 based on the historical data stored at the database 122, as discussed herein. The AI and cognitive processing layer 202 actively recommends optimal strategies for network decisions such as inventory replenishment, shipment rerouting, and demand forecasting.

Market and supply factors also represent disruptions that can impact the supply chain network as represented by the virtual representation along with operations and inventory management associated with the supply chain network. These factors encompass supply shortages that affect inventory levels along with supplier performance issues and outages that can create cascading effects throughout the supply chain network as represented by the virtual representation 300. Supply chain disruptions of this nature often manifest as unexpected shortages of critical materials or components, forcing end users to rapidly adjust procurement strategies, seek alternative suppliers, or modify production schedules. The management system 102 accounts for these supply-related challenges as external factors that require attention and proactive response strategies to maintain operational continuity. The AI and cognitive processing layer 202 provides recommendations to address these challenges as discussed herein.

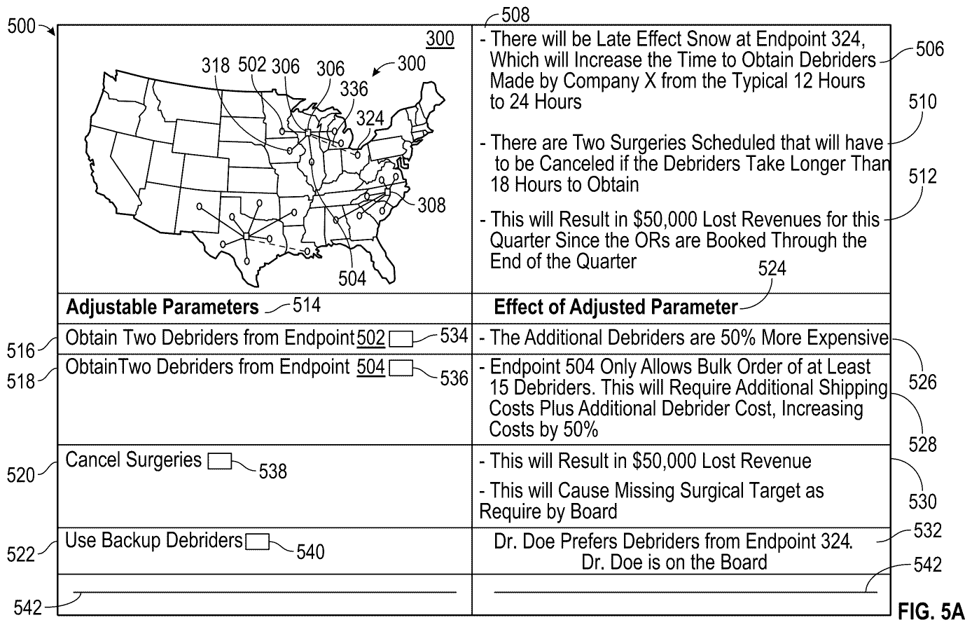

The optimal strategies are pushed through both the digital twin layer 200 and a user interface/immersive user experience layer 205 for display on a dashboard 500 (FIGS. 5A and 5B). Thus, examples not only provide end users with data visualization, such as the virtual representation 300, but actionable recommendations and the ability to respond to identified anomalies and supply chain disruptions.

Based on selections made by the end users with regards to the actionable recommendations, this can create a feedback loop where the management system 102 continuously refines machine learning models at the AI and cognitive processing layer 202 based on end user decisions and real-world outcomes, as monitored by the virtual representation software/hardware 120. This feedback loop increases automated responses to routine supply chain challenges while freeing end users to focus on higher-level strategic planning.

The data integration layer 206 serves as a mechanism by which external data is captured and ingested from various enterprise systems such as a TMS 208, a WMS 210, and ERP systems 212, as well as external data sources like weather, traffic, and geopolitical data. This integration occurs through various APIs where the management system 102 pulls in data 214-222 and then ingests and cleans the data 214-222. Cleaning the data 214-222 can include removing any personally identifiable information (PII). The management system 102 can then store the data 214-222 at the database 122 for real-time access and historical access. Thus, the management system 102 can simulate and predict the impact of external factors on supply chain operations, including weather-related disruptions (such as hurricanes, floods, lake effect snow, and polar cyclones), geopolitical events (including trade restrictions, tariffs, and border closures), infrastructure and transportation factors (like highway construction, port closures, and traffic conditions), location-specific incidents (strikes, accidents), and market/supply factors (supply shortages and supplier outages) and the like.

The virtual representation software/hardware 120 also includes a data processing layer 224 that performs real-time anomaly detection and data analysis.

The data processing layer 224 operates alongside the AI and cognitive processing layer 202 to analyze the data 214-222. The data processing layer 224 continuously monitors incoming data streams in real-time and detects anomalies in the data 214-222 while looking for insights that can be provided to an end user. The data processing layer 224 processes data from multiple enterprise systems and external sources that have been captured through the data integration layer, such as the TMS 208, the WMS 210, the ERP system 212, and third-party APIs 226. The third-party APIs 226 can correspond to external data sources such as weather, traffic, and geopolitical information that can be obtained from the source devices 112-118.

The data processing layer 224 employs threshold-based analysis to identify anomalies in supply chain operations. The data 214-222 can have a certain flow. To further illustrate, the data 214 can relate to traffic patterns at roadways represented by the electronic connection 336. The data 214 can also relate to the possibility of lake effect snow affecting the region at the endpoint 324. The traffic patterns at the roadways represented by the electronic connection 336 can normally indicate that a travel time between the hub 306 and the endpoint 324 is between a first range of 10 hours and 14 hours. However, recent data acquired by the data processing layer 206 and the third-party APIs 226 can indicate that the travel time for a given day will be between a second range of 20 hours and 28 hours. Moreover, weather data gleaned from the third-party APIs 226 can indicate that snowstorms are expected at locations 346 and 348 and lake effect snow is expected at a location 350 associated with the endpoint 324. The data processing layer 224 can identify the difference in travel times, i.e., the difference between the first range and the second range, as an anomaly.

The anomalous data relating to the difference between the first time range and the second time range is provided to the AI and cognitive processing layer 202. Moreover, the weather data relating to the snowstorms at the locations 346 and 348 and the lake effect snow at the location 350 associated with the endpoint 324 is provided to the AI and cognitive processing layer 202. The AI and cognitive processing layer 202 is trained to identify that the lake effect snow will be a potential disruption to supply chain operations. Here, the endpoint 324 may provide articles 352 to the hub 306. The AI and cognitive processing layer 202 can be trained to deduce that, because of the weather, the hub 306 should obtain the articles 352 from a different endpoint, such as one of the endpoints 320 and 322. In particular, the lake effect snow will be disruptive to the endpoint 324 providing the articles 352 to the hub 306.

Moreover, the AI and cognitive processing layer 202 can determine what effects there will be by obtaining the articles 352 from one of the endpoints 320 and 322. For example, if the articles 352 cost more at the endpoints 320 and 322, the AI and cognitive processing layer 202 can determine these costs and display the costs on the dashboard 500. The AI and cognitive processing layer 202 can also list the effects, such as the effects on any planned capital expenditures since costs will rise for the articles 352, or the like. The AI and cognitive processing layer 202 can also recommend whether or not the articles 352 should be obtained from one of the endpoints 320 and 322. The AI and cognitive processing layer 202 can also recommend obtaining the articles 352 from the endpoint 318 and list the effects of obtaining the articles from the endpoint 318. Again, the AI and cognitive processing layer 202 can list the effects for obtaining the articles 352 from the endpoint 318.

The virtual representation software/hardware 120 has an extensibility and customization layer 228 that has a flexible framework that enables organizational and individual personalization of the management system 102. The extensibility and customization layer 228 couples with the user interface/immersive user experience layer 205 and functions to allow viewing of the virtual representation 300 and the dashboard 500. The extensibility and customization layer 228 enables the management system 102 to accommodate different organizational structures and individual user preferences by storing customization settings in the database 122. Furthermore, the extensibility and customization layer 228 allows for the addition of new tools, modules, and integrations to meet changing needs of end users.

The extensibility and customization layer 228 also allows for different entities to customize the management system 102 in different ways. For example, a Chief Financial Officer (CFO) may desire to have a view of the virtual representation 300 that is different from a view of a Chief Supply Chain Officer (CSCO). Moreover, an accountant may have a desire for a view of the virtual representation 300 that is different from a view of the virtual representation 300 for the CFO and CSCO. The extensibility and customization layer 228 allows for the CFO, the CSCO, and the accountant to customize their views. In addition, as the needs of the different entities change, the extensibility and customization layer 228 allows the users to make changes regarding what is displayed by the virtual representation 300. For example, if a Chief Revenue Offer (CRO) leaves, the CFO can change their view of the virtual representation 300 to include what the CRO would normally view until a new CRO is installed.

The virtual representation software/hardware 120 has a data storage layer 230 that maintains real-time data, such as the data 214-222, and historical data for easy access within the management system 102. The data storage layer 230 functions as a repository for data that has been captured and processed through the data integration layer 206. The data storage layer 230 functions to remove personally identifiable information (PII) from the data 214-222 during a data cleaning process, which can include parsing complex fields into components, gap filling, and data enrichment. Once PII has been removed from the data 214-222, the data 214-222 is addressed in real time, and then stored as historical data at the database 122.

The dual-purpose functionality of the data storage layer 230 enables the management system 102 to support both immediate operational needs and analytical comparisons across different time periods. Thus, end users can analyze events occurring in real-time while comparing the real-time events to events that previously occurred. The data storage layer 230 creates a temporal data foundation that supports the predictive modeling capabilities, digital twin simulations, and AI-driven analytics of the management system 102, as described herein. The data storage layer 230 accomplishes this by maintaining a comprehensive record of data, such as supply chain operations, that can be accessed for both current decision-making and historical pattern analysis. The stored data can also be used to identify anomalies, generate predictive insights, and enable scenario modeling by providing the historical context necessary for the AI and cognitive processing layer 202 to make recommendations and detect deviations from normal operational parameters.

In addition to the data storage layer 230, the virtual representation software/hardware 120 has a collaboration and workforce layer 232 that enables multi-stakeholder coordination and role-based access to supply chain intelligence. The collaboration and workforce layer 232 takes the data 214-222 from the TMS 208, the WMS 210, the ERP systems 212, and the third-party APIs 226 and gleans insights from the data 214-222 and the TMS 208, the WMS 210, the ERP systems 212, and the third-party APIs 226 to reveal insights that would not be apparent individually. For example, the system can combine data from the TMS 208, the WMS 210, the ERP systems 212, and the third-party APIs 226 to identify supply chain issues. When the data 220 shows normal shipping times, the data 218 indicates reduced order quantities, and the data 216 reveals a price increase, the combination of these insights can suggest a supply chain disruption, such as a lack of materials used to generate the articles associated with the data 216-220, that would not be visible in any individual data source.

Accordingly, the collaboration and workforce layer 232 recognizes that different end users view data differently. The collaboration and workforce layer 232 allows different end users to focus on different aspects of the virtual representation 300 and a supply chain associated with the virtual representation 300. To further illustrate, in a hospital setting, a CFO may focus on a pricing perspective, a reimbursement perspective, and an insurance perspective, while a technician responsible for supplying operating rooms with medical equipment may focus on medical equipment availability by a certain time. Thus, the CFO and the technician require different views related to inventory in the hospital setting. The collaboration and workforce layer 232 provides the different views.

The collaboration and workforce layer 232 also embeds insights into workflows associated with different end users, such as the CFO and the technician. The insights can relate to the costs embedded for the CFO and medical equipment availability embedded for the technician. The management system 102 enables real-time communication via any type of medium, such as email, direct messaging, and the like where the different end users can share insights with each other via the management system 102. Thus, if the CFO decides to stop using a certain piece of medical equipment, the management system 102 can inform the technician of the decision via messaging. The technician can then indicate that the certain piece of medical equipment is necessary for various medical procedures that otherwise could not be performed. Thus, the management system 102 can facilitate collaborative insights among different end users.

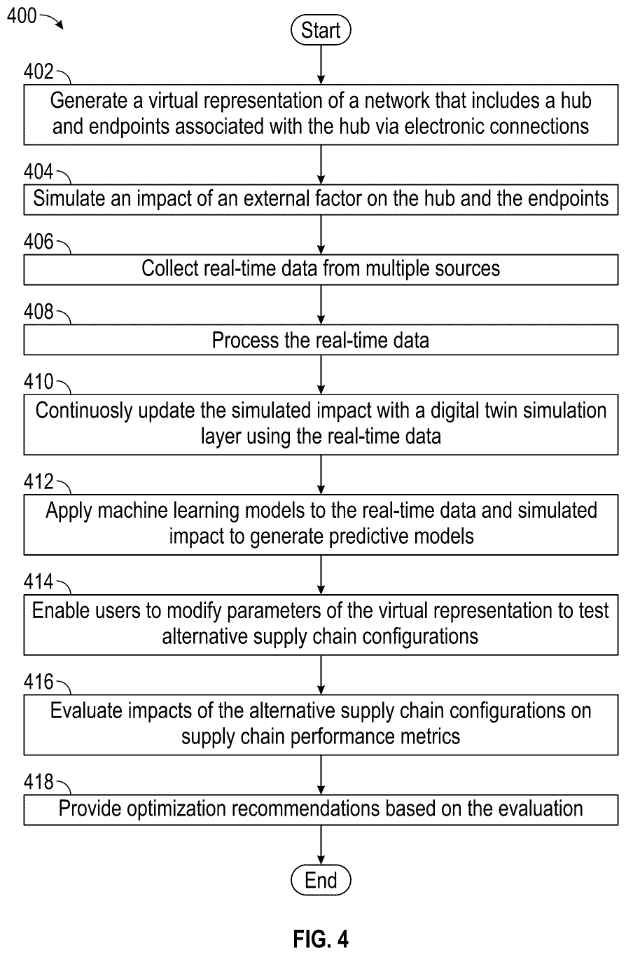

The management system 102 determines effects of supply chain changes and generates optimized recommendations through a multi-layered analytical process that begins with real-time data integration from the TMS 208, the WMS 210, the ERP systems 212, and the third-party APIs 226, which feeds into a comprehensive digital twin simulation that creates the virtual representation 300 of a supply chain network. When changes occur, the management system 102 employs both deterministic and stochastic modeling with probability-based analysis using belief maps that calculate multiple probability scenarios for every potential change. Mathematical functions include weights and events to bring together hundreds of different probabilities into optimal outcomes. The data processing layer 224 identifies anomalies by comparing current data against established thresholds and historical patterns, which then triggers the AI and cognitive processing layer 202 to create agents on-the-fly that analyze identified anomalies and generate specific recommendations ranging from most conservative to most aggressive approaches. The management system 102 correlates data from multiple sources that individually might not show issues but together provide comprehensive insights, and utilizes machine learning algorithms for predictive modeling while continuously learning from outcomes of past decisions to enhance accuracy over time. The digital twin layer 202 presents multiple recommendation levels with calculated cost-benefit analyses, risk assessments, and operational impact evaluations, allowing end users to select approaches that align with their risk tolerance and operational requirements Now making reference to FIG. 4, a method 400 for providing a management system that graphically presents a supply-chain network using a variety of tools is shown. The method 400 can be performed by the management system 102 and the virtual representation software/hardware 120. Moreover, the operations described below can be performed in situ at when predictions are being made. During an operation 402, the management system 102 implements the digital twin layer 200 to generate the virtual representation 300 of a supply chain network that includes the hubs 302-308, the endpoints 310-324, and electronic connections 326-336, as discussed above. After the virtual representation 300 is generated, an impact of an external factor of the supply chain network and in particular on the hubs 302-308 and the endpoints 310-324 is simulated during an operation 404. External factors can include weather-related factors, geopolitical and regulatory factors, infrastructure and transportation factors, location-specific incidents (as described above), market and supply factors (as described above), and the like.

Weather-related factors can encompass a wide range of natural weather events, including severe weather conditions such as hurricanes and floods, lake effect snow that can significantly impact transportation routes and delivery times, and polar cyclones coming from Canada that affect shipping routes. The management system 102 also accounts for general weather conditions that impact transportation and logistics, recognizing that even routine weather patterns can create operational challenges that require proactive management and response strategies.

The management system 102 accounts for geopolitical events that can affect international supply chains, such as the supply chain network of the virtual representation 300. These can include trade restrictions, tariffs, and border closures that disrupt normal logistics flows. These geopolitical factors can create cascading effects throughout supply networks, affecting shipping times, costs, and overall supply chain resilience. The management system 102 enables organizations to simulate various geopolitical scenarios, such as trade restrictions or tariffs that affect cross-border shipments, border closures that disrupt international logistics, or the like. By modeling these geopolitical risks, the management system 102 allows for the evaluation of alternative hubs of the hubs 302-308, endpoints of the endpoints 310-324, and/or electronic connections of the electronic connections 326-336 located in regions with more stable trade agreements. The management system 102 also forecasts the long-term impact of geopolitical shifts on supply chain operations.

The management system 102 incorporates regulatory changes that impact supply chain operations and compliance requirements, enabling organizations to adapt to evolving legal and policy landscapes. These regulatory factors can affect everything from customs procedures and documentation requirements to safety standards and environmental compliance across different jurisdictions. The scenario planning capabilities of the management system 102 allow for the simulation of potential regulatory changes and potential regulatory changes on supply chain operations. This regulatory intelligence can be relevant for cross-border commerce, where changing import/export regulations, customs requirements, and international trade agreements can significantly affect supply chain costs, timing, and feasibility.

The management system 102 accounts for infrastructure-related disruptions such as highway construction-related events that cause delays, port closures that affect shipping schedules, and traffic conditions that impact delivery times on the electronic connections 326-336. These infrastructure challenges create cascading effects throughout supply networks, affecting transportation routes, shipping times, and overall operational efficiency. Transportation delays from various causes can alter planned logistics flows, requiring the development of adaptive strategies that account for both predictable infrastructure maintenance and unexpected transportation bottlenecks. The management system 102 integrates real-time transportation and infrastructure data to provide continuous monitoring of these factors.

Referring back to FIG. 4 and the operation 404, the AI and cognitive processing layer 202 and the data processing layer 224 work in conjunction with each other as described above to determine what events may affect the hubs 302-308 and the endpoints 312-324 and what those impacts will be. Once the AI and cognitive processing layer 202 and the digital processing layer 224 make those determinations, the determinations are provided to the digital twin layer 200, which updates the supply chain network as represented by the virtual representation 300. For example, and referred to herein as “the illustration,” the simulation can relate to a lake effect snow occurring in the northern United States and simulating the impact on the endpoint 324 by virtue of the status indicators 344 on the electronic connection 336.

The method 400 also collects real-time data from various sources during an operation 406 and then processes the real-time data during an operation 408. During the operation 406, the data integration layer 206 collects real-time data, such as the data 214-222 as discussed above. During the operation 408, the AI and cognitive processing layer 202, in conjunction with the data integration layer 206, processes the real-time data, as discussed above. Returning to the illustration, real-time data from the third-party APIs 226 indicates lake effect snow occurring at a location associated with the endpoint 324, as described above. The AI and cognitive processing layer 202 determines that the lake effect snow will effect the electronic connection 336 and hence travel times to and from the endpoint 324.

Returning attention to FIG. 4, the method 400 continuously updates the simulated impact using the digital twin layer 200 with the real-time data during an operation 410. In the illustration, the digital twin layer 200 can update the supply chain network as represented by the virtual representation 300 to reflect that the electronic connection 336 will be impacted by the lake effect snow. The digital twin layer 200 can make the update by implementing the status indicator 344, as shown on the virtual representation 300.

Returning attention to FIG. 4, the method 400 also performs an operation 412 where a machine learning model is applied to the real-time data and the simulated impact to generate predictive models. The predictive models can relate to how entities associated with endpoints exposed to external factors will be affected. Thus, if one of the endpoints 310-324, such as a supplier at a first location, is being exposed to/affected by external factors as listed above, the impact to a second location, which can be another of the endpoints 310-324 or one of the hubs 304-308, such as a distributor, can be determined using predictive models as described above. Additionally, the output of the predictive models can be output to an end user.

During an operation 414, the method 400 enables end users to adjust parameters of the virtual representation to test alternative supply chain configurations. The parameters can include changing one of the endpoints 310-324 at the first location to another of the endpoints 310-324 at a third location, and changing the one of the hubs 304-308 to another of the hubs 304-308. The parameters can be displayed on the dashboard 500, where the dashboard 500 can provide functionality to allow the end user to select one of the parameters.

Continuing with the method 400, in addition to enabling end users to adjust parameters, the management system 102 and the virtual representation software/hardware 120 evaluate impacts of the alternative supply chain configuration on supply chain performance metrics during an operation 416. In particular, the virtual representation software/hardware 120 can determine the downstream effects on the supply chain network as represented by the virtual representation 300 that upstream changes will create using predictive modeling as described herein.

Returning to the illustration and FIG. 5A, the hub 306, which is a hospital, obtains medical equipment, which includes stents, forceps, syringes, and catheters, from the endpoint 336 along with the endpoints 318, 336, 502, and 504. The hub 306 also obtains debriders from the endpoint 336. The AI and cognitive processing layer 202 determines that due to the lake effect snow forecast at the endpoint 326, the delivery time will increase from the typical 12 hours to 24 hours, as shown with text 506 at a display area 508. The AI and cognitive processing layer 202 also determines that two surgeries scheduled at the hub 306 will have to be canceled if the debriders are not obtained within 18 hours, as shown with text 510. The AI and cognitive processing layer 202 makes this determination by accessing the database 122, which lists surgeries that are taking place at the hub 306.

The AI and cognitive processing layer 202 also determines that the hub 306 will incur a revenue loss of $50,000 for the current quarter if the surgeries are cancelled. The AI and cognitive processing layer 202 makes this determination by accessing historical data stored at the database 122 and applying a machine learning model to the stored data. The AI and cognitive processing layer 202 also determines that the operating rooms (ORs) are booked through the end of the quarter and thus makes the current quarter revenue loss determination.

Still staying with the illustration, during the operation 414, the management system 102 and the virtual representation software/hardware 120 enable end users to modify parameters of the virtual representation to test alternative supply chain configurations. In particular, the digital twin layer 200 operates to list adjustable parameters 514 are listed on the dashboard 500. The adjustable parameters 514 include parameters 516-522. The parameter 516 relates to obtaining two debriders from the endpoint 502. The parameter 518 relates to obtaining two debriders from the endpoint 504. The parameter 520 relates to canceling the surgeries and the parameter 522 relates to using backup debriders.

The parameters 516-522 correlate to alternative supply chain configurations. During the operation 416, the management system 102 and the virtual representation software/hardware 120 evaluate impacts of the parameters 516-522 on the supply chain performance metrics using predictive modeling. The digital twin layer 200 outputs the determinations made by the AI and cognitive processing layer 202 on the dashboard as an effect of adjusted parameters 524. The effect of adjusted parameters 524 includes effects 526-532.

The effect 526 indicates that the additional debriders from the endpoint 502 are 50% more expensive. The effect 528 shows that the endpoint 504 only allows bulk ordering of at least 15 debriders. The effect 528 also shows that the increased amount of debriders will increase shipping costs along with the increased costs of buying additional debriders such that overall costs will increase by 50%. The effect 530 illustrates that canceling the surgeries will result in $50,000 lost revenues along with missing a surgical target set out by the Board of the hub 306. The effect 532 illustrates that if backup debriders are used, this will not appease Dr. Doe because Dr. Doe prefers to use debriders from the endpoint 324 during surgical procedures. This is also important because Dr. Doe is a member of the Board of the hub 306.

The dashboard can include elements 534-540, which can be engaged by an end user to adjust the listed parameter. Thus, if the end user would like to obtain two debriders from the endpoint 502, the end user can select the element 534. Moreover, if the end user would like to obtain two debriders from the endpoint 504, the end user can select the element 536. Similarly, if the end user would prefer to cancel the surgeries, the end user can select the element 538. If the end user decides to use backup debriders, the end user can select the element 540.

The dashboard can also provide an area that allows an end user to enter an adjustable parameter not listed by the management system 102 and the virtual representation software/hardware 120. In particular, the dashboard 500 can include a landing 544 where an end user can input an adjustable parameter not listed on the dashboard 500. The management system 102 and the virtual representation software/hardware 120 can then determine the effect of adjusting the parameter entered at the landing 542 and output the effect at a landing 544.

Returning to FIG. 4 and the method 400, the management system 102 and the virtual representation software/hardware 120 also provide optimized recommendations based on evaluating the impacts during an operation 418. The optimized recommendations are determined using the AI and cognitive processing layer 202, the data integration layer 206, and the data processing layer 224 along with predictive modeling as discussed above. Moreover, the digital twin layer 200 outputs the optimized recommendations on the dashboard 500.

Returning to the illustration, during the operation, the management system 102 and the virtual representation software/hardware 120 determine optimized recommendations and then output the optimized recommendations on the dashboard 500 as shown in FIG. 5B. The dashboard 500 has a recommendations card 546 that includes a recommendation 548. In the illustration, the management system 102 and the virtual representation software/hardware 120 recommend that the end user obtain two debriders from the endpoint 504.

Examples also provide an end user with the capability to make adjustments to the supply chain network as represented by the virtual representation 300. In particular, still making reference to FIG. 5B, the dashboard 500 provides an end user the ability to adjust parameters on the virtual representation 300. Furthermore, when parameters are adjusted, the management system 102 and the virtual representation software/hardware 120 render a new virtual representation 600 that represents an updated supply chain network.

As shown with reference to FIG. 5B, the dashboard 500 includes a virtual representation adjustment card 550 having parameters 552-556 that are selectable via checkboxes 558-562. When an end user selects one of the checkboxes 558-562, the management system 102 and the virtual representation software/hardware 120 render the virtual representation 600. The parameter 552 corresponds to weather impacts on electronic connections. The parameter 554 corresponds to sporting event impacts on electronic connections. The parameter 556 corresponds to regional impacts on a supply chain network. Regional impacts can relate to local ordinances, social events, such as protests, and the like.

Here, an end user learns that the location of an endpoint 602 will be hosting a major sporting event for a two week period of time. The end user desires to know if the major sporting event will impact an electronic connection 604. Thus, the end user selects the checkbox 560 and the management system 102 and the virtual representation software/hardware 120 generate the virtual representation 600 as described herein. The virtual representation 600 shows, via a status indicator, that the electronic connection 604 will be experiencing problems. Thus, examples allow an end user to make changes to a supply chain network on the fly and view the impact on the supply chain network in real-time via a virtual representation that is generated based on the virtual representation adjustment 550. In examples, the management system 102 and the virtual representation software/hardware 120 may become aware of the major sporting event at the location of the endpoint 602 via the data integration layer 206 as discussed herein and provide a recommendation to the end user at the recommendations card 546.

An end user may also adjust various features of the supply chain network as represented by the virtual representation 300 via the dashboard 500. The dashboard 500 can include a supply chain impacts card 564 having selectable parameters 566-570. The parameters 566-570 can be selected by selecting a corresponding checkbox 572-576, as shown with reference to FIG. 5B. The parameter 562 corresponds to adjusting/changing an endpoint. The parameter 564 corresponds to acquiring a different number of articles. The parameter 570 corresponds to obtaining articles at a different time. The different time can relate to a different time of day, a different day of the week, or the like. When an end user selects one of the checkboxes 572-576 or any combination of the checkboxes 572-576, the management system 102 and the virtual representation software/hardware 120 will generate a new virtual representation.

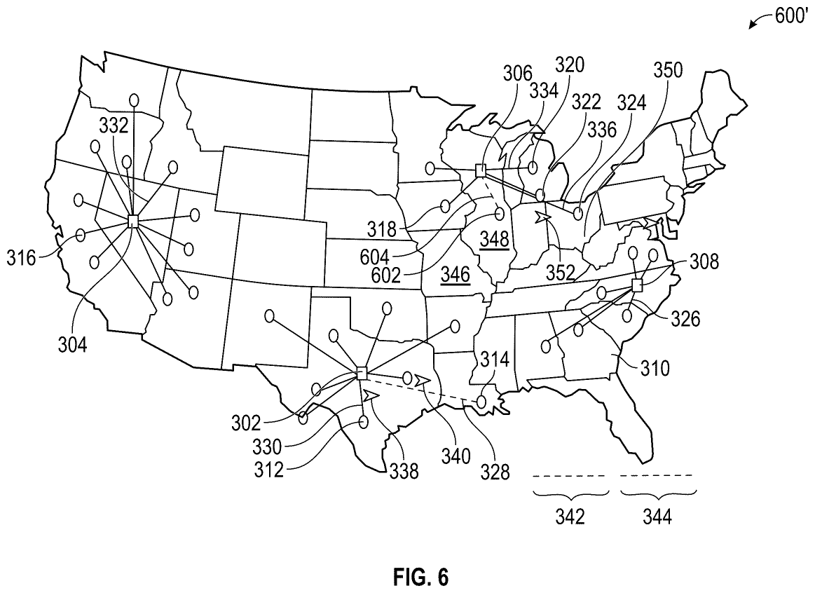

Making reference to FIG. 7, the management system 102 includes a natural language interaction interface that receives user queries in the form of inputs in a natural language format regarding supply chain operations associated with the supply chain. The dashboard 500 has a card 700 that functions as a natural language interaction interface and receives verbal inputs from an end user. The verbal inputs are displayed at the natural language card 700 in order to allow the end user to make any edits to the verbal input. The management system 102 can implement speech-to-text software, machine translation software, dictation and voice recognition software, or the like to provide the functionality of the natural language card 700.

To further illustrate, an end user could provide the following verbal input at one of the user devices 106 or 108:“What are the impacts of obtaining additional articles 354 from an end point 356 and reducing the number of the articles obtained from an endpoint 358?” at the natural language interface card 700. The dashboard 500 also includes an advantages card 702 and a disadvantages card 704.

The advantages card 702 lists advantages 706 and 708. The advantage 706 indicates that increased savings will result since Arizona, the location of the end point 354, does not collect corporate sales tax. The advantage 708 indicates that the endpoint 356 is more reliable than the endpoint 358.

The disadvantages card 704 lists disadvantages 710 and 712. The disadvantage 710 indicates that obtaining additional articles 354 from the endpoint 356 will result in increased shipping costs. The disadvantage 712 indicates that the endpoint 356 requires bulk orders of ten of the articles 354.

When an end user provides a verbal input, the management system 102 and the virtual representation software/hardware 120 also provide a recommendation 714 at a recommendation card 716 that is optimized as described herein. Here, the management system 102 and the virtual representation software/hardware 120 determine that the advantages 706 and 708 outweigh the disadvantages 710 and 712 and provide the recommendation 714 that indicates the end user should obtain additional ones of the articles 354 from the endpoint 356 eight months out of the year to account for the increased order amount using the techniques described herein.

The management system described herein represents a comprehensive implementation of an AI-native, closed-loop orchestration platform (CLO) that operates as a mission-control layer positioned above existing enterprise systems 5. While the preceding sections have detailed the individual technical layers and components of the management system—including the digital twin layer, AI and cognitive processing layer, data integration capabilities, and real-time analytics—the following describes how these components are architected and orchestrated within a unified platform framework that enables governed, auditable, and financially-constrained decision-making across complex operational environments. This platform architecture transforms the technical capabilities previously described into an integrated control plane that can inform, decide, and execute actions across healthcare, supply chain logistics, and other mission-critical domains, providing the governance, security, and compliance frameworks necessary for enterprise-scale deployment of the management system's AI-driven decision-making capabilities Management System Overview. The CLO functions as an orchestration layer above enterprise systems, connecting internal (ERP, EHR, WMS, TMS, scheduling, finance) and external signals into a closed-loop decision engine. Core layers include DHX (data harmonization), DRI (decision routing), CTD (digital-twin sandbox), and CRT (financial guardrails), enabling the platform to inform, decide, and execute. DRX supplies the governed control plane and services for agents/models and knowledge access: a unified/v1/invoke façade and direct/v1/agents . . . : predict and /v1/models . . . : predict endpoints with lineage, uncertainty, and reason codes, with RBAC/PBAC, dual-key auth, guardrails, and audit. The management system does not require bulk data movement: users can train models locally and register artifacts via BYOM; prediction-time access reads in-situ enterprise data, preserving residency and minimizing Protected Health Information (PHI) exposure.

Integration Layer and Connectors. The Integration Layer provides multi-protocol ingestion and event streaming (Kafka/Webhooks), ETL/validation, and pre-built connectors (ERP/EHR/WMS/TMS/CRM), with security, monitoring, and compliance frameworks. Supported protocols include REST, GraphQL, WebSockets, MQTT, gRPC, and EDI for cross-enterprise and IoT connectivity.

Governed Agent & Model Orchestration (DRX). The control plane enforces dual-key authentication, RBAC/PBAC, AI guardrails, and comprehensive audit logging across calls, agents, models, and data access, with policy controls for latency, freshness, rate limits, and cost. A model registry (e.g., MLflow) registers artifacts and signatures; tenants can list and invoke agents/models (staging/prod) and roll forward/back versions. The unified invoke and direct predict endpoints return recommendation identifiers, actions, confidence, reason codes, uncertainty, latency, and lineage (model name/version, feature snapshot hash, training window). Each prediction is emitted as a first-class Prediction Event into the CLO event store, with event_id, timestamps, entity_ref, target/value, uncertainty, reason_codes, producer (system/agent_id/request_id), lineage (model/version/snapshot hash/training window), and optional explainability link. Contracts are versioned and predictions are not co-mingled with facts by default.

An agent declares context identifiers (IDs) (facility_id, unit_id), features (e.g., census, orders_ready, acuity_score), optional exogenous inputs (weather_zip), model binding (provider/name/version/artifact), policies (max_latency_ms, freshness_sec, rate_limit_rps), and outputs (target, event_sink=prediction_events, reason_codes, uncertainty, lineage) with optional explainability/accountability webhook/redaction.

Data Residency, Privacy, and Compliance. Privacy-by-design includes PHI minimization and redaction at the gateway; structured logs store hashes and lineage rather than raw PHI. Integration security uses OAuth2/JWT, TLS 1.3, AES-256; compliance includes HIPAA, GDPR, and SOC2 with end-to-end auditability.

Digital-Twin Simulation (CTD) and Decision Routing (DRI). CTD exposes a 3D sandbox for scenario planning; DRI routes insights and workflows to role-based agents (C-suite to frontline). The platform ties visibility to simulation and action rather than remaining a point tool.

Financial Guardrails (CRT). The CRT layer integrates treasury datasets with operational intelligence to provide real-time cash modeling and programmable guardrails aligned to risk tolerance; embedding finance into the same closed-loop operating system used for decisions and actions.

Observability and Service Level Objectives (SLOs). OpenTelemetry traces across CTD→DRX→sinks, Grafana dashboards for p50/p95/p99, and SLOs. Error contracts include graceful degradation for upstream staleness.

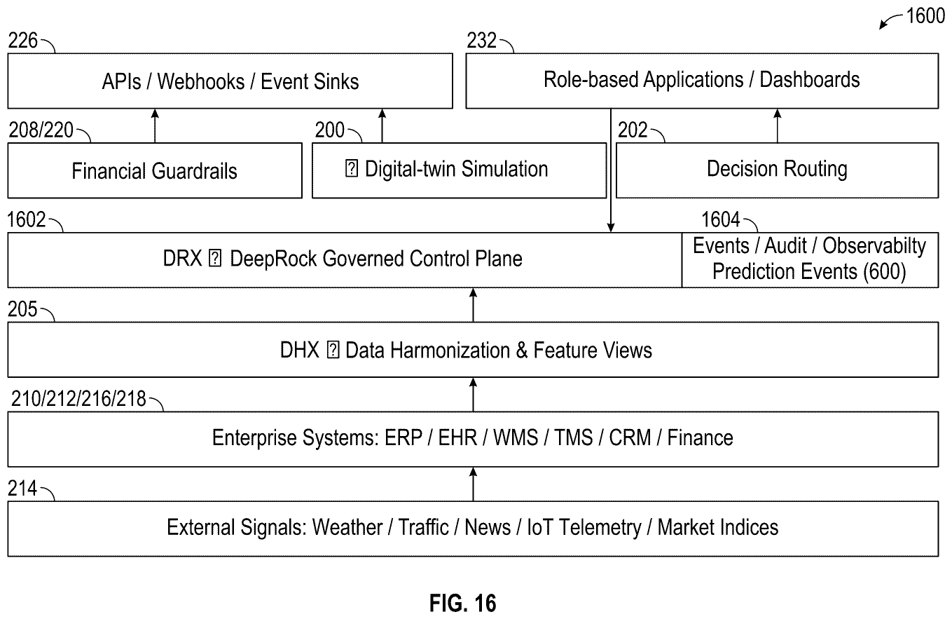

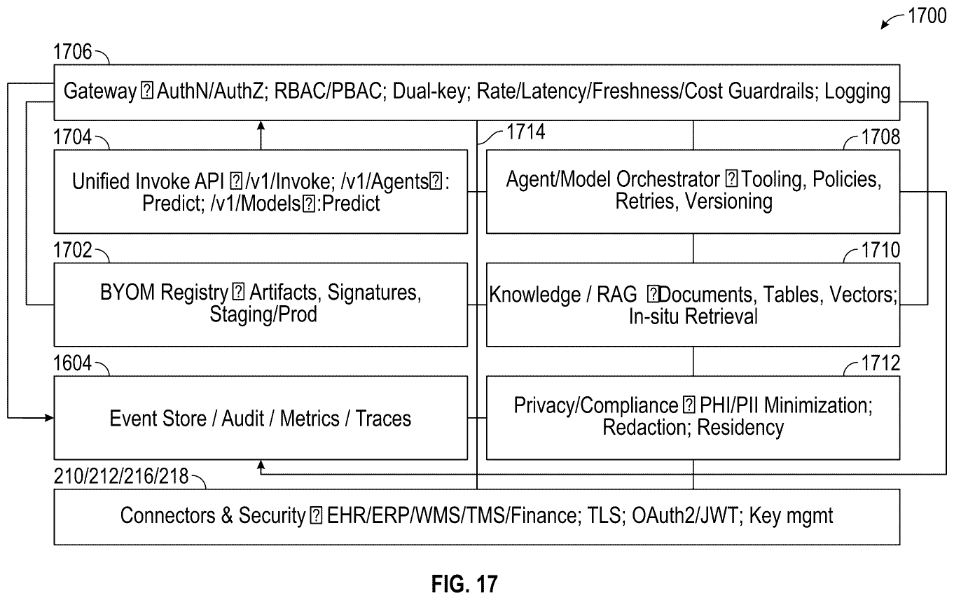

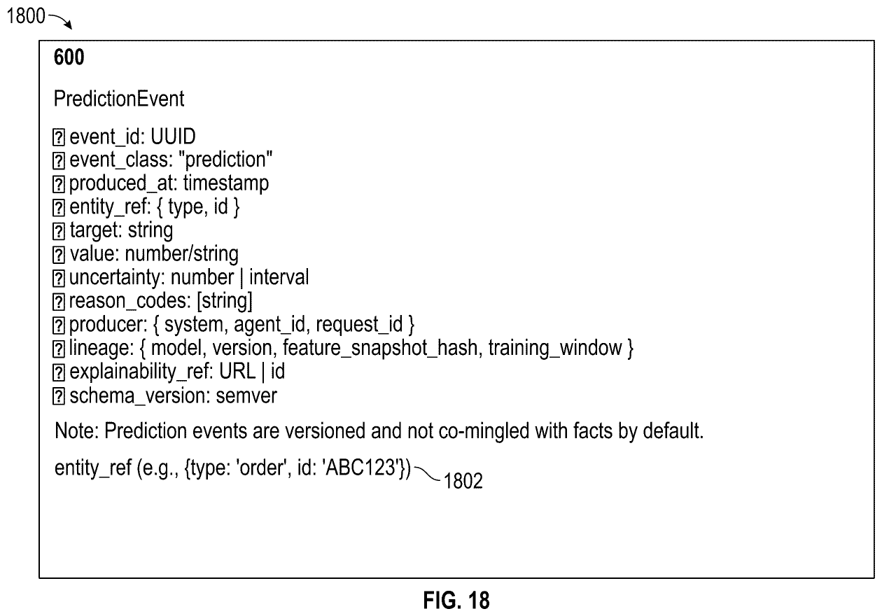

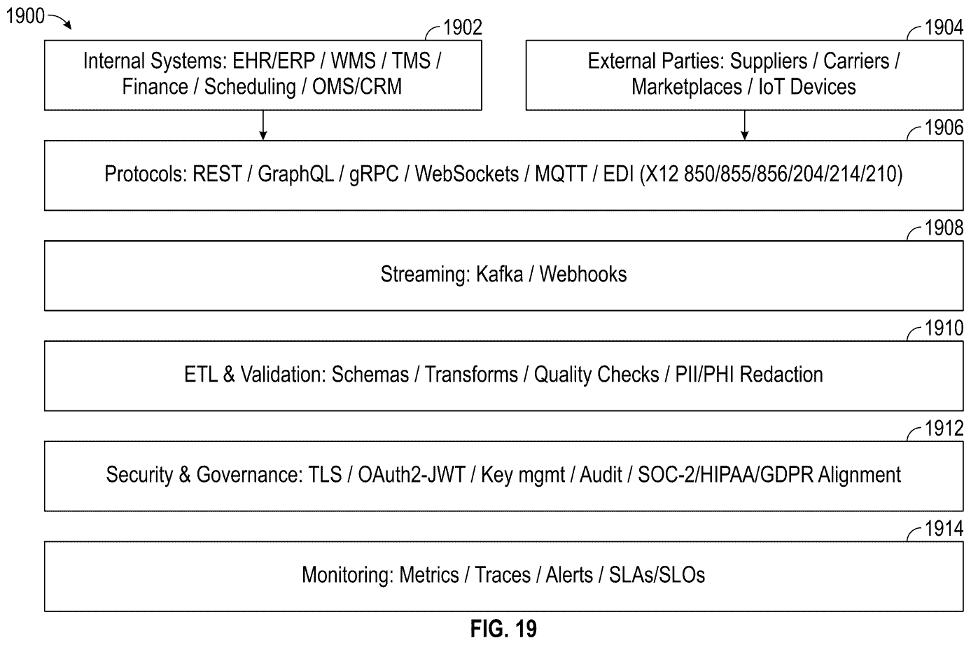

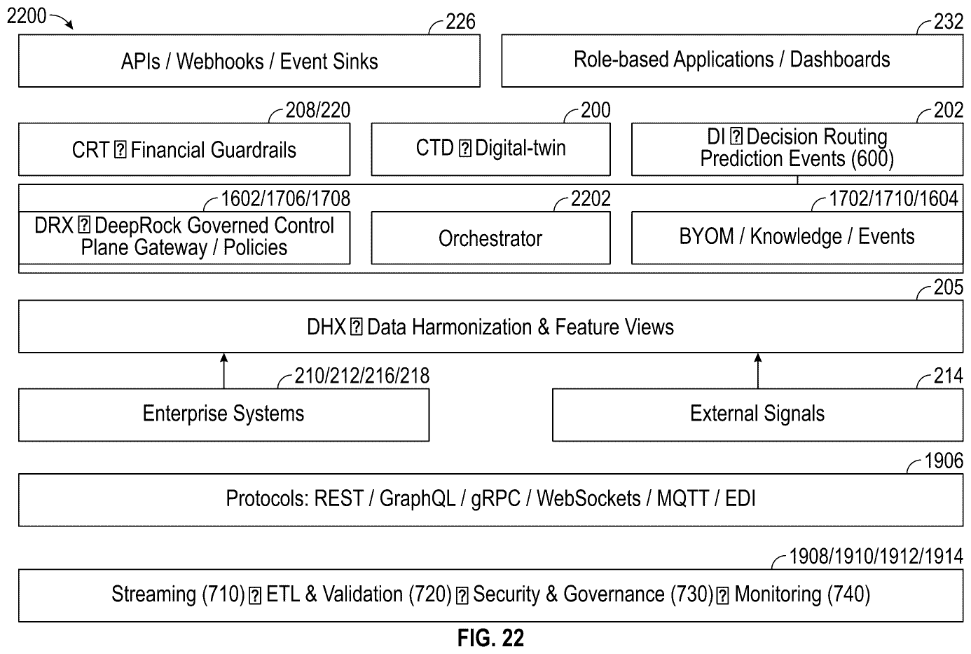

The system ingests operational data from enterprise systems 210/212/216/218 in FIG. 16 and external signals 1904 in FIG. 19, harmonizes and features the data within DHX 205 as shown in FIG. 22, and exposes governed AI capabilities via DRX 1602/1706/1708 in FIGS. 16 and 22. DRX authenticates and authorizes requests, enforces per-tenant and per-invocation guardrails, orchestrates agent/model execution, records artifacts and traces into 1604 in FIGS. 16 and 17, and emits prediction events 1800 in FIG. 18 to downstream consumers, including CTD 200 in FIGS. 16 and 22, CRT 208/220 in FIGS. 16 and 22, and DI 202 in FIGS. 16 and 22.

Data Harmonization (DHX). DHX standardizes schemas, applies quality checks, computes derived features, and maintains feature views synchronized to source-of-truth systems. DHX guarantees that event lineage references (e.g., feature snapshot hashes) used by prediction events 1800 in FIG. 18 are reproducible and auditable.

Governed Control Plane (DRX). The DRX gateway 1706 in FIG. 17 implements identity, access, and policy evaluation; the orchestrator 1708 in FIG. 17 manages invocation plans, retries, and tool access; the BYOM registry 1702 in FIGS. 17 and 22 admits externally supplied models with signature validation and staged promotion; knowledge services 1710 in FIG. 17 enable retrieval-augmented generation against governed corpora; and privacy/compliance (300) enforces PHI/PII minimization, redaction, and data-residency constraints.

Prediction Events. Each prediction event 1800 in FIG. 18 includes producer identity, explainability references, model/version identifiers, training window metadata, and uncertainty. Events are immutable and versioned, kept distinct from factual telemetry to preserve audit semantics. Consumers include CTD 200 in FIGS. 16 and 22, 208/220 in FIGS. 16 and 22, and DI 202 in FIGS. 16 and 22.

Digital-Twin Simulation (CTD). CTD maintains entity graphs, constraints, and state machines representing the target environment (e.g., hospital units or supply nodes). CTD validates proposed actions arising from prediction events, runs scenario branches, and highlights constraint violations (e.g., resource contention, lead-time windows, clinical or safety rules).

Financial Guardrails (CRT). CRT evaluates candidate actions against budget limits, cost envelopes, and policy constraints, computing tradeoffs and sensitivities (e.g., cost-to-serve, service-level impact). CRT may decline or modify actions before routing.

Decision Routing (DI). DI transforms approved actions into executable operations across connected systems via APIs, webhooks, or EDI transactions, and records resulting state changes into the event/audit store 1604 in FIGS. 16 and 17 for closed-loop learning.

Interfaces. Developers access the platform via APIs and event sinks 226 in FIGS. 16 and 22, 1704 in FIG. 17. End users interact through role-based applications 232 in FIGS. 16 and 22 that display live status, recommendations, simulation outcomes, and guardrail rationales, each linked to underlying prediction events 1800 in FIG. 18 and DRX traces. Representative Examples

Example A (Healthcare Mission Control): A hospital deploys CLO above ERP/EHR. DRX agents close the loop from patient intake through claim submission by orchestrating data, models, workflows, and financial guardrails across existing systems, and emit Prediction Events containing uncertainty and reason codes; CTD simulates staffing and inventory impacts; CRT guards purchasing decisions with cash policy. This example reduces authorization delays, improves OR utilization, mitigates stock-outs, and ties operational actions to financial policy. By coupling governed agentic execution with digital-twin simulation and financial guardrails - and by emitting explainable, lineage-rich Prediction Events - the system converts fragmented clinical and supply signals into auditable, economically compliant, and automatable decisions across the patient journey.

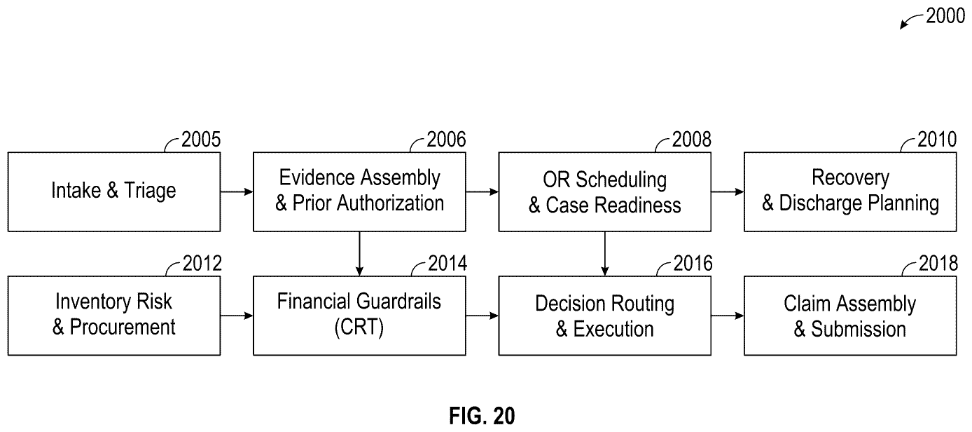

Clinical Intake & Triage 2005 in FIG. 20. DHX harmonizes EHR intake data. DRX orchestrates a triage agent to estimate acuity and downstream resource demand, producing prediction events 1800 in FIG. 18 with uncertainty bounds and rationale references.

Evidence Assembly & Prior Authorization 2006 in FIG. 20. Knowledge services 1710 in FIG. 17 assemble relevant clinical evidence and payer policy snippets. CTD validates scheduling feasibility and resource availability; CRT evaluates cost and payer constraints; DI submits prior-auth requests or escalations with full lineage.

OR Scheduling & Case Readiness 2008 in FIG. 20. Prediction events estimate case duration, material usage, and staffing. CTD simulates slotting against constraints (e.g., turnover times, sterilization cycles). CRT checks budget impact; DI books theatre slots and material kits via EHR and inventory interfaces.

Recovery & Discharge Planning 2010 in FIG. 20. Models predict length-of-stay and discharge readiness. CTD evaluates downstream bed availability and post-acute capacity; DI initiates orders and discharge packets; CRT verifies payer and cost limits; all actions append events and traces to 1604 in FIGS. 16 and 17.

Inventory Risk & Procurement 2012 in FIG. 20. Supply predictions flag stock-out risk. CTD simulates pull-forward or substitution. CRT evaluates contract and price ladders; DI executes purchase orders via ERP/WMS integrations; monitoring 1914 in FIG. 19 tracks fulfillment SLAs.

Financial Guardrails 2014 in FIG. 20. CRT applies payer, service-line, and departmental budgets to candidate actions; thresholds may throttle agent/model calls under cost or latency pressure and defer low-value recommendations.

Decision Execution 2016 in FIG. 20 & Claims 2018 in FIG. 20. DI executes approved actions with idempotent strategies; claim assembly uses explainability references and DRX audit traces to support utilization review and appeals.

Example B (Supply-Chain Logistics and Operations): CLO operates as a network-wide logistics mission control that closes the loop from order capture through final delivery by orchestrating governed agents/models, a digital-twin network simulator, and financial guardrails across ERP/OMS/WMS/TMS, suppliers, carriers, and customer channels. Integration Layer streams carrier, WMS, and supplier data via REST/gRPC/MQTT; agentic models perform inventory and transportation risk forecasting; events flow to CTD/UI with lineage and explainability links; actions attach provenance and policy. This embodiment improves On-Time In-Full (OTIF) and fill rate, lowers expedites and accessorials, reduces dwell and yard congestion, and aligns operational choices with working-capital and margin goals. By pairing governed agentic execution with network digital-twin simulation and financial guardrails—and by emitting explainable, lineage-rich Prediction Events—the system turns fragmented multi-party signals into auditable, SLA-aware, and automatable decisions spanning order promise, inventory positioning, transportation, and delivery.

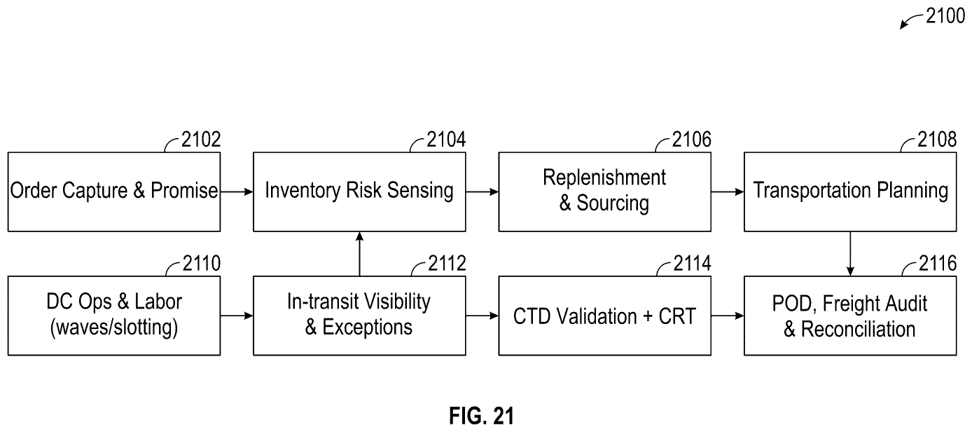

Order Capture & Promise 2102 in FIG. 21. DHX harmonizes order, inventory, and capacity signals. DRX invokes promise-time models; events 1800 in FIG. 18 quantify fill-rate risk and lead-time uncertainty; CTD validates feasibility under constraints.

Inventory Risk Sensing 2104 in FIG. 21. Streaming 1908 in FIGS. 19 and 22 ingests telemetry and EDI; models predict stock-out and spoilage. CTD evaluates reorder and substitution scenarios; CRT evaluates cost-to-serve; DI places replenishment orders.

Replenishment & Sourcing 2106 in FIG. 21. Orchestrator 1708 in FIGS. 17 and 2202 in FIG. 22 evaluates sourcing options with constraints (MOQs, lead times). CTD simulates network impacts; CRT estimates landed cost; DI issues POs and ASNs; monitoring (740) verifies confirmations.

Transportation Planning 2108 in FIG. 21. Models propose mode/route plans; CTD checks capacity and appointment windows; CRT compares cost/delivery tradeoffs; DI tenders loads and books carriers via TMS/EDI (204/214/210).

Distribution Center (DC) Operations & Labor 2110 in FIG. 21. Prediction events estimate labor waves and slotting. CTD validates dock, pick, and pack constraints; DI issues tasking; CRT ensures labor budget adherence.

In-Transit Visibility & Exceptions 2112 in FIG. 21. Streaming exceptions trigger re-plan proposals; CTD simulates diversion/expedite; CRT approves spend; DI executes updates to stops, carriers, or appointments.

CTD Validation+CRT 2114 in FIG. 21 and Reconciliation 2116 in FIG. 21. All routed actions are validated in CTD and checked by CRT; reconciliation records PODs, freight audit results, and adjustments, closing the loop in events/audits/observability 1604 in FIGS. 16 and 17

### Prediction Event Schema and Governance

Schema Guarantees. The event schema (FIG. 3) requires producer ID, model/version, training window, uncertainty, explainability references, and snapshot lineage. Schema versioning prevents co-mingling with factual telemetry and enables reproducible analysis.

Policy & Privacy. DRX enforces RBAC/PBAC, PHI/PII minimization and redaction, residency, and cryptographic signing of artifacts. Dual-key or step-up authorization is supported for sensitive actions.

Cost/Latency Guardrails. DRX evaluates invocation plans against policy budgets (compute cost, model latency, data freshness) and may throttle, batch, or fall back to cached results where policy requires.

### Integration, Protocols, and Monitoring

Protocols. The integration stack (FIG. 4) includes REST/GraphQL/gRPC/WebSockets/MQTT and EDI (X12 850/855/856/204/214/210). Streaming/webhooks 1908 in FIGS. 19 and 22 support near-real-time updates. ETL/validation 1910 in FIG. 19 enforces schema integrity and PII/PHI redaction. Security/governance 1912 in FIGS. 19 and 22 manages TLS, OAuth2/JWT, keys, audit, and compliance (e.g., SOC-2, HIPAA). Monitoring 1914 in FIGS. 19 and 22 emits metrics, traces, and alerts tied to SLAs/SLOs.

Events, Audit, and Replay. All invocations, artifacts, decisions, and external side effects are recorded in event/audit store 1604 in FIGS. 16 and 17. Replay re-drives decisions from events and snapshots to validate improvements and support regulatory review.

### Non-Limiting Implementations

Computing Environment. One or more processors execute instructions stored on non-transitory media to implement the described components. Deployments may be on-premises, in a cloud, or hybrid. Interfaces may be provided via web, mobile, or embedded applications.

Extensibility. The platform is model-and agent-agnostic; new tools, retrieval sources, and policies may be registered and promoted through the BYOM registry 1702 in FIGS. 17 and 22 and DRX policy workflows without service interruption.

Modifications. Various changes may be made without departing from the scope of the claims. The figures and examples are illustrative and not limiting.

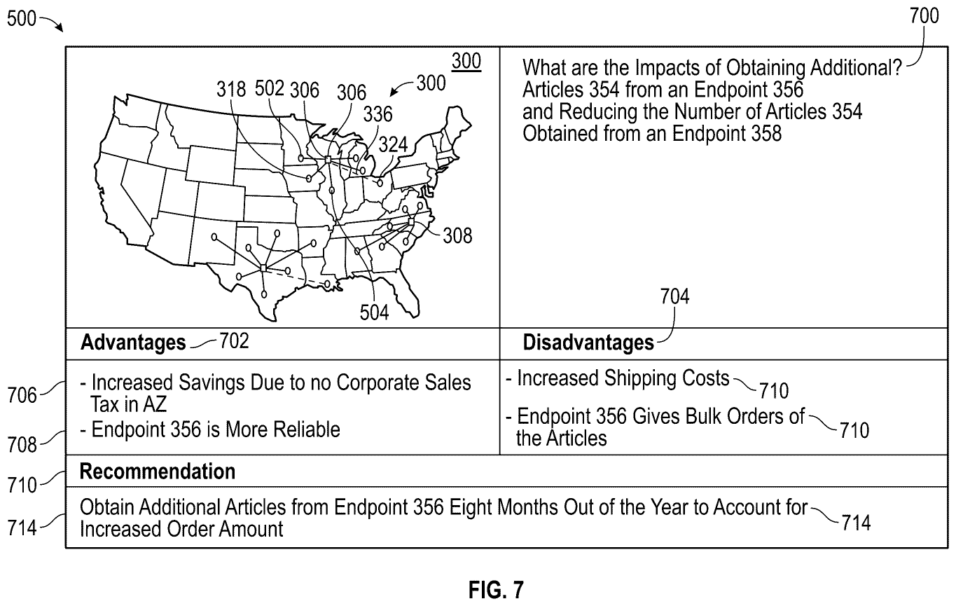

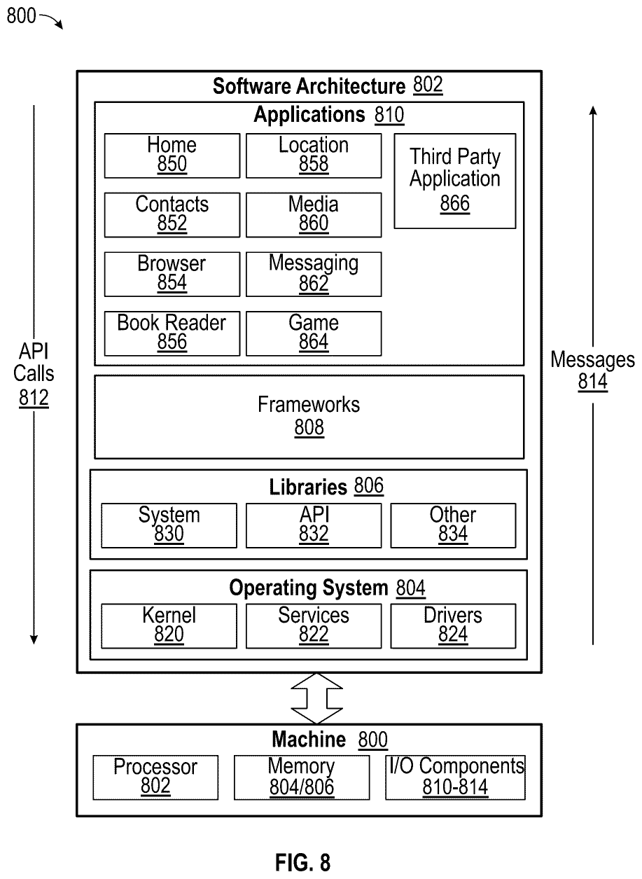

FIG. 8 is a block diagram 800 illustrating a software architecture 802, which may be installed on any one or more of the devices described above. FIG. 9 is merely a non-limiting example of a software architecture, and it will be appreciated that many other architectures may be implemented to facilitate the functionality described herein. The software architecture 802 may be implemented by hardware such as a computer system 900 of FIG. 9 that includes a processor 902, memory 904 and 906, and I/O components 910-914. In this example, the software architecture 802 may be conceptualized as a stack of layers where each layer may provide a particular functionality. For example, the software architecture 802 includes layers such as an operating system 804, libraries 806, frameworks 808, and applications 810. Operationally, the applications 810 invoke application programming interface (API) calls 812 through the software stack and receive messages 814 in response to the API calls 812, according to some implementations.

In various implementations, the operating system 804 manages hardware resources and provides common services. The operating system 804 includes, for example, a kernel 820, services 822, and drivers 824. The kernel 820 acts as an abstraction layer between the hardware and the other software layers in some implementations. For example, the kernel 820 provides memory management, processor management (e.g., scheduling), component management, networking, and security settings, among other functionality. The services 822 may provide other common services for the other software layers. The drivers 824 may be responsible for controlling or interfacing with the underlying hardware. For instance, the drivers 824 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

In some implementations, the libraries 806 provide a low-level common infrastructure that may be utilized by the applications 810. The libraries 806 may include system libraries 830 (e.g., C standard library) that may provide functions such as memory allocation functions, string manipulation functions, mathematic functions, and the like. In addition, the libraries 806 may include API libraries 832 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 806 may also include a wide variety of other libraries 834 to provide many other APIs to the applications 810.

The frameworks 808 provide a high-level common infrastructure that may be utilized by the applications 810, according to some implementations. For example, the frameworks 808 provide various graphic user interface (GUI) functions, high-level resource management, high-level location services, and so forth. The frameworks 808 may provide a broad spectrum of other APIs that may be utilized by the applications 810, some of which may be specific to a particular operating system or platform.

In an example, the applications 810 include a home application 850, a contacts application 852, a browser application 854, a book reader application 856, a location application 858, a media application 860, a messaging application 862, a game application 864, and a broad assortment of other applications such as a third-party application 866. According to some examples, the applications 810 are programs that execute functions defined in the programs. Various programming languages may be employed to create one or more of the applications 810, structured in a variety of manners, such as object-orientated programming languages (e.g., Objective-C, Java, or C++) or procedural programming languages (e.g., C or assembly language). In a specific example, the third-party application 866 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party application 866 may invoke the API calls 812 provided by the mobile operating system (e.g., the operating system 804) to facilitate functionality described herein.

Certain examples are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In examples, one or more computer systems (e.g., a standalone, client or server computer system) or one or more processors may be configured by software (e.g., an application or application portion) as a hardware-implemented module that operates to perform certain operations as described herein.

In various examples, a hardware-implemented module may be implemented mechanically or electronically. For example, a hardware-implemented module may include dedicated circuitry or logic that is permanently configured (e.g., as a special-purpose processor, such as a field programmable gate array (FPGA) or an application-specific integrated circuit (ASIC)) to perform certain operations. A hardware-implemented module may also include programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering examples in which hardware-implemented modules are temporarily configured (e.g., programmed), each of the hardware-implemented modules need not be configured or instantiated at any one instance in time. For example, where the hardware-implemented modules include a general-purpose processor configured using software, the general-purpose processor may be configured as respectively different hardware-implemented modules at different times. Software may, accordingly, configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses) that connects the hardware-implemented modules. In examples in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some examples, include processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but also deployed across a number of machines. In some examples, the processor or processors may be located in a single location (e.g., within a home environment, an office environment or as a server farm), while in other examples, the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via the network 110 (e.g., the Internet) and via one or more appropriate interfaces (e.g., application program interfaces (APIs).) Examples may be implemented in digital electronic circuitry, or in computer hardware, firmware, software, or in combinations of them. Examples may be implemented using a computer program product, e.g., a computer program tangibly embodied in an information carrier, e.g., in a machine-readable medium for execution by, or to control the operation of data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers, at one site or distributed across multiple sites, and interconnected by a communication network.

The computing system can include clients and servers. A client and server are generally remote from each other and typically interact through a communication network. The relationship of client and server arises by virtue of computer programs running on the respective computers and having a client-server relationship to each other. In examples deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various examples.

FIG. 9 is a block diagram of a machine within which instructions may be executed for causing the machine to perform any one or more of the methodologies discussed herein. In one example, the machine may be any of the devices described above. In alternative examples, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that, individually or jointly, execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a user interface (UI) navigation device (cursor control device) 914 (e.g., a mouse), a disk drive unit 916, a signal generation device 918 (e.g., a speaker) and a network interface device 920.

The drive unit 916 includes a machine-readable medium 922 on which is stored one or more sets of instructions and data structures (e.g., software) 924 embodying or utilized by any one or more of the methodologies or functions described herein. The instructions 924 may also reside, completely or at least partially, within the main memory 904 and/or within the processor 902 during execution thereof by the computer system 900, the main memory 904 and the processor 902 also constituting machine-readable media. Instructions 924 may also reside within the static memory 906.

While the machine-readable medium 922 is shown in an example to be a single medium, the term “machine-readable medium” may include a single medium or multiple media (e.g., a centralized or distributed database, and/or associated caches and servers) that store the one or more instructions or data instructions 924. The term “machine-readable medium” shall also be taken to include any tangible medium that is capable of storing, encoding or carrying instructions 924 for execution by the machine and that cause the machine to perform any one or more of the methodologies of the present invention, or that is capable of storing, encoding or carrying data structures utilized by or associated with such instructions 924. The term “machine-readable medium” shall accordingly be taken to include, but not be limited to, solid-state memories, and optical and magnetic media. Specific examples of machine-readable media include non-volatile memory, including by way of example, semiconductor memory devices, e.g., erasable programmable read-only memory (EPROM), electrically erasable programmable read-only memory (EEPROM), and flash memory devices; magnetic disks, such as internal hard disks and removable disks; magneto-optical disks; and CD-ROM and DVD-ROM disks.

The instructions 924 may further be transmitted or received over the network 110 using a transmission medium. The instructions 924 may be transmitted using the network interface device 920 and any one of a number of well-known transfer protocols (e.g., HTTP). Examples of communication networks include a local area network (“LAN”), a wide area network (“WAN”), the Internet, mobile telephone networks, plain old telephone (POTS) networks, and wireless data networks (e.g., Wi-Fi and Wi-Max networks). The term “transmission medium” shall be taken to include any intangible medium that is capable of storing, encoding or carrying instructions 924 for execution by the machine, and includes digital or analog communications signals or other intangible media to facilitate communication of such software.

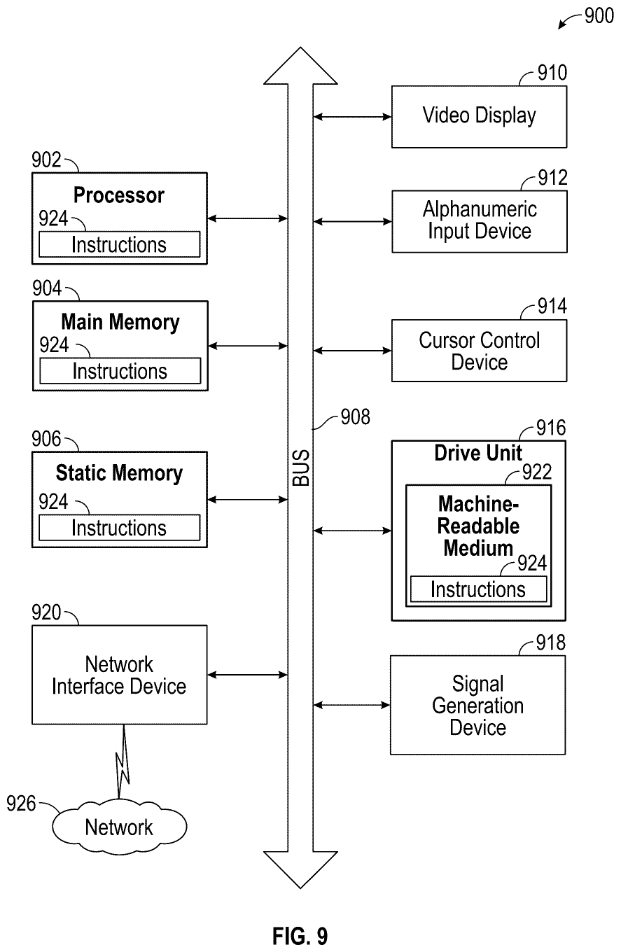

FIG. 10 is a layered block diagram of the mission-control stack (CLO) showing enterprise systems and external signals feeding a data harmonization layer (DHX), a governed control plane (DRX), the mid-tier of CRT (financial guardrails), CTD (digital-twin simulation), and DRI (decision routing), and the upper interfaces (APIs/event sinks and role-based applications).

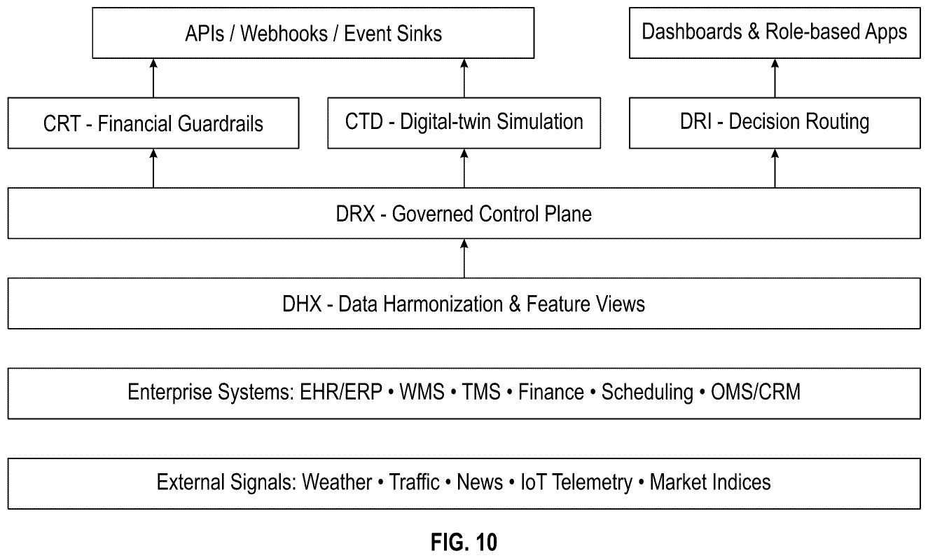

FIG. 11 is a component diagram of the governed DRX control plane illustrating the gateway (authentication/authorization and guardrails), unified invoke APIs, agent orchestrator, machine learning model registry, knowledge/RAG layer, event stores, observability, privacy/compliance, connectors, and security services, with indicative data/control flows.

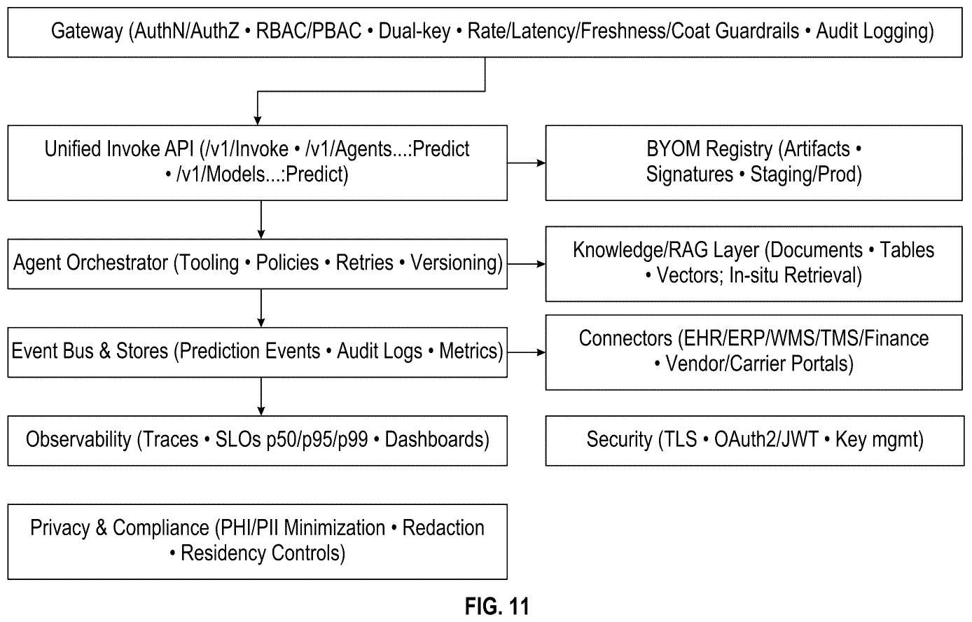

FIG. 12 is a schema overview of the Prediction Event contract identifying representative fields including event identifiers, class, timestamps, entity reference, target/value, uncertainty, reason codes, producer metadata, lineage (model/version/feature snapshot/training window), explainability reference, and schema version.

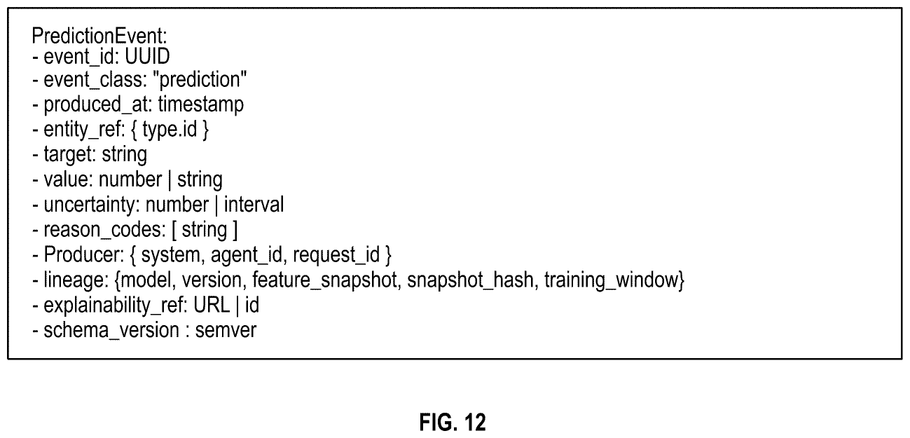

FIG. 13 is an integration and protocol topology diagram showing internal systems and external parties connecting into a standardized protocol layer (REST, GraphQL, gRPC, WebSockets, MQTT, and EDI), above streaming (Kafka/Webhooks), ETL/validation, security/governance, and monitoring layers.

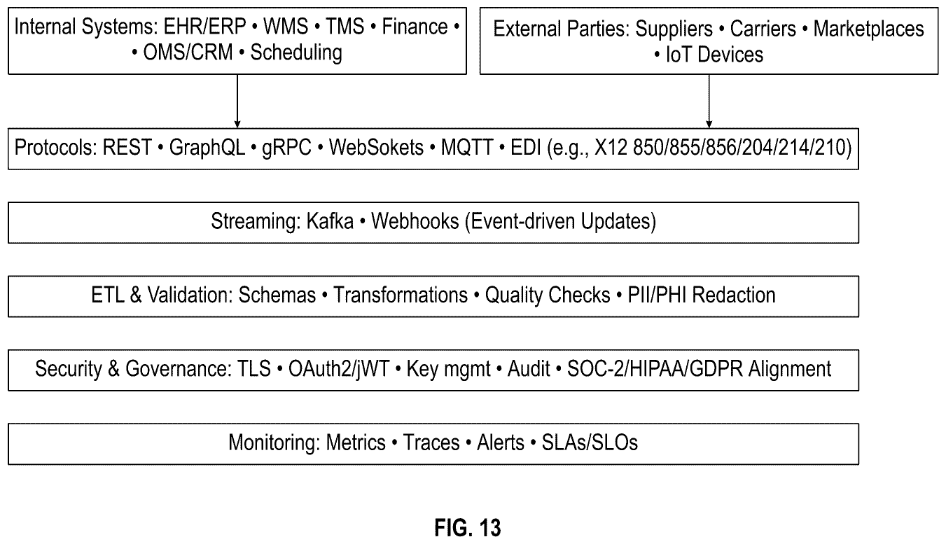

FIG. 14 is a swim-lane flow diagram for a Healthcare Mission Control example depicting intake/triage, evidence assembly and prior authorization, operating room scheduling and case readiness, recovery and discharge planning, inventory/procurement orchestration, CRT evaluation, decision routing/execution, and claim assembly/submission with key cross-lane handoffs. Row 1400 represents a clinical operations swim lane. Row 1402 represents a supply/finance lane.

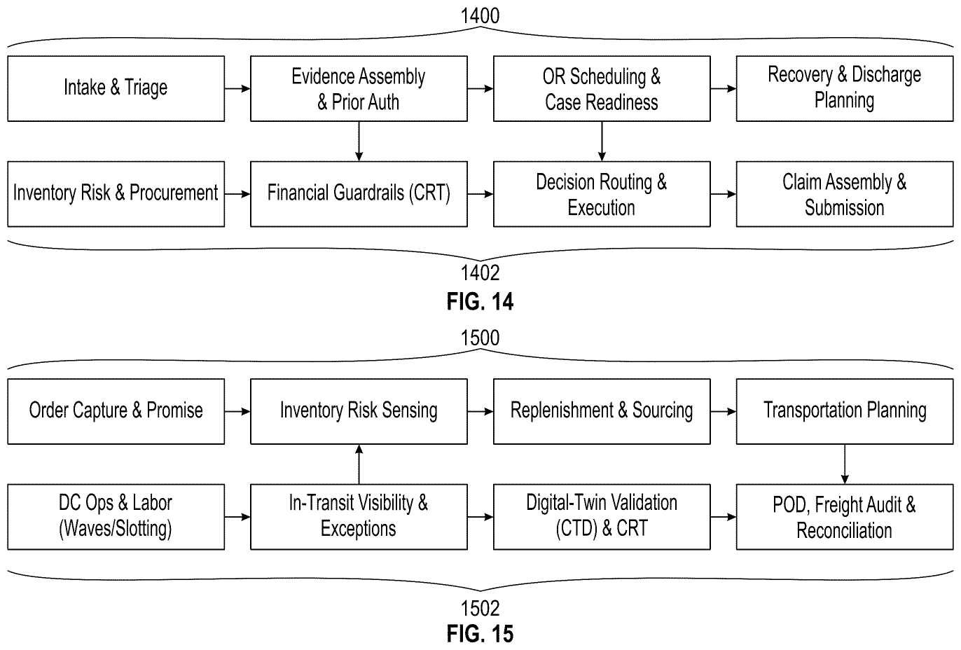

FIG. 15 is a swim-lane flow diagram for a Supply-Chain Logistics Mission Control example depicting order capture and promise, inventory risk sensing, replenishment and sourcing, transportation planning, DC operations and labor, in-transit visibility and exception management, CTD validation with CRT, and proof-of-delivery with freight audit and reconciliation. Row 1500 represents a plan and source swim lane. Row 1502 represents an execute and reconcile swim lane.

Now making reference to FIG. 16, an application stack 1600 is shown. The application stack shows the interconnections of some of the layers described herein in accordance with further examples. Here, the digital twin layer 200 can include digital twin simulation and the AI and cognitive processing layer 202 can also include decision routing in addition to the other features described herein. The user interface/immersive user experience layer 205 can also include a Document exchange protocol (DHX) and can function as a deeprock governed control plane in addition to the other features described herein. The digital twin layer 200 can communicate with the third-party APIs 226, where the third-party APIs can include webhooks and event sinks in addition to the other features described herein. The AI and cognitive processing layer 202 can communicate with the collaboration and workforce layer 232, where the collaboration and workforce layer 232 can include and generates role-based applications and dashboards in addition to the other features described herein. The digital twin layer 200 can communicate with and interface with the third-party APIs 226 layer.

The application stack 1600 can also have the TMS 208 and the data 220 layers that can also include financial guardrails in addition to the other features described herein where the TMS 208 and the data 220 layers can communicate with and interface with the third-party APIs 226 layer. Moreover, the application stack 1600 can have the WMS 210, the ERP system 212, and the data 216/218 layer, where this can include enterprise systems having TMS, EHR, CRM, and finance components where these can communicate with and interface with the TMS 205. Furthermore, the application stack 1600 can have the data 214, which can include external signals such as weather, traffic, news, IoT telemetry, and market indices.

The application stack 1600 can also have a discontinuous reception (DRX) layer 1602 along with an events/audit/observability layer 1604. In the application stack 1600, the collaboration and workforce layer 232 can communicate with and interface with the DRX layer 1602. Moreover, the TMS 205 layer can communicate with and interface with the DRX layer 1602. In addition, the WMS 210, the ERP system 212, and the data 216/218 can communicate with and interface with the TMS 205 layer.

Now making reference to FIG. 17, an application stack 1700, which can be a governed control plane, is shown. The application stack 1700 can include the WMS 210, the ERP system 212, and the data 216/218 layer, as described above. The application layer 1700 can also have the events/audit/observability layer 1604. The application layer 1700 also has a bring your own model (BYOM) layer 1702 that includes a registry, phi artifacts, signatures, and staging/products. Moreover, the application layer 1700 has a unified invoke API layer 1704 and a gateway layer 1706. The unified invoke API layer 1704 has/v1/invoke;/v1/agents□: predict; /v1/models: predict features. The gateway layer 1706 has AuthN/AuthZ; RBAC/PBAC; dual-key; rate/latency/freshness/cost guardrails; logging features.

Moreover, the application layer 1700 includes an agent/model orchestrator layer 1708, a/owledge/ Retrieval-Augmented Generation (RAG) layer 1710, and a privacy compliance layer 1712. The agent/model orchestrator layer 1708 includes tooling, policies, retries, versioning features. The knowledge/RAG layer 1710 has documents, tables, vectors; in-situ retrieval features. The privacy/compliance layer 1712 has protected health information (PHI)/PII minimization; redaction; residency features.

All of the layers in the application layer 1700 can be coupled with each other via a bus 1714. Moreover, the gateway layer 1706 can communicate with and interface with the events/audit/observability layer 1604. The API layer 1704 can communicate with and interface with the gateway layer 1706. The agent/model orchestrator layer 1708 can communicate with and interface with the events/audit/observability layer 1604.

FIG. 18 illustrates a prediction event contract (schema) 1800 having various fields that includes event_id, class, produced_at, entity_ref, target, value, uncertainty, reason_codes, producer, lineage (model/version/feature_snapshot_hash/training_window), explainability_ref, schema_version). Add/Change: Draw as a UML-style class box with field names and types; mark schema_version explicitly. The prediction events may avoid co-mingling with facts by default along with versioned contracts.” If space allows, add example entity_ref (e.g., {type: ‘order’, id: ‘ABC123’}) 1802.

Now making reference to FIG. 19, an integration and protocol topology 1900 is shown. The integration and protocol topology 1900 can operate in the ERP/EHR/WMS/TMS/CRM, carrier portals, IoT devices domains. The integration and protocol topology 1900 includes an internal systems layer 1902 having EHR, ERP, WMS, TMS, Finance, Scheduling, OMS, and CRM features. The integration and protocol topology 1900 also has an external parties layer 1904 that includes suppliers, carrier, marketplaces, and IoT devices. Each of the internal systems layer 1902 and the external parties layer 1904 can communicate with and interface with a common protocol layer 1906. Protocols that can be used can include REST/GraphQL/gRPC/WebSockets/MQTT/EDI (X12 850/855/856/204/214/210). The integration and protocol topology 1900 also has a streaming layer 1908 and a extract, transform, and load (ETL)/validation layer 1910. The streaming layer 1908 can utilize Kafka or webhooks. The ETL/validation layer 1910 can include schemas/transforms/quality checks/PII/PHI redaction. The integration and protocol topology 1900 can also have a security governance layer 1912 and a monitoring layer 1914. The security governance layer 1912 can include TLS/OAuth2-JWT/key management/audit/SOC-2/HIPAA/GDPR alignment. The monitoring layer 1914 can monitor metrics, traces, alerts, SLAs, and SLOs.

FIG. 20 illustrates a swim lane example of healthcare mission control 2000 implementation. The healthcare mission control implementation can be performed with the devices and methodologies described herein. A first lane corresponds to clinical operation and a second lane corresponds to supply/finance. The first lane includes operations 2005-2010. The second lane includes operations 2012-2018. At the clinical operation lane 2002, intake and triage first occur at 2004 and then evidence assembly and prior authorization occur at 2006. After evidence assembly and prior authorization occur, operating room scheduling and case readiness are performed and determined at 2008. After operating room scheduling/case readiness are performed/determined, recovery and discharge planning is performed at 2010.

At the supply/finance lane 2004, inventory risk and procurement is performed at 2012 and then financial guardrails (CRT) is performed at 2014. Subsequently, decision routing and execution re performed at 2016. After decision routing/execution, claim assembly and submission associated with procedure performed according to the clinical operation lane 2002 is performed. As can be seen with reference to FIG. 20, the operation 2006 is related to the operation 2014 where the operations 2006 and 2014 can work in conjunction with one another. Moreover, as can be seen with reference to FIG. 20, the operation 2008 is related to the operation 2016 where the operations 2008 and 2016 can work in conjunction with one another.

FIG. 21 illustrates a swim lane example of supply-chain logistics mission control 2100 implementation. The supply-chain logistics mission control implementation can be performed with the devices and methodologies described herein. A first lane corresponds to planning and sources having operations 2102-2108. A second lane corresponds to executing and reconciling having operations 2110-2116.

At 2102, order capture for goods/services and promise to provide goods/services are performed. At 2104. Inventory risk sensing is performed and at 2106, replenishment and sourcing is performed. At 2108, transportation planning for remitting the goods/services is performed.

At operation 2110 DC ops and labor (waves/slotting) is performed and In-transit visibility and exceptions are determined at 2112. At 2114, CTD validation along with CRT are performed. At 2116, point of delivery (POD), freight audit & reconciliation are performed. As can be seen with reference to FIG. 21, the operation 2112 is related to the operation 2104 where the operation 2112 can work in conjunction with the operation 2104. In addition, as can be seen with reference to FIG. 21, the operation 2108 is related to the operation 2116 where the operation 2108 can work in conjunction with the operation 2116.

Now making reference to FIG. 22, a platform architecture 2200 is shown. The platform architecture 2200 is a consolidated view of the features of FIGS. 16,17, and 19.

### Additional Examples

Example 1 is a computer-implemented orchestration system for hospital operations and supply-chain intelligence, comprising: a governed control plane including a gateway enforcing authentication, authorization, and policy constraints for model and agent execution; an agent orchestration engine coupled to a model registry that registers externally trained models and exposes a unified invocation interface; a retrieval-augmented knowledge layer configured to access enterprise systems without bulk data movement; a digital-twin simulation layer configured to simulate operational scenarios; a financial guardrail layer configured to evaluate actions against liquidity and policy constraints; and an event subsystem configured to emit Prediction Events comprising fields that include, event identifiers, timestamps, an entity reference, a target variable and predicted value, uncertainty, reason codes, producer details, and lineage linking a model name, version, feature snapshot hash, and training window.

In Example 2, the subject matter of Example 1 includes, wherein the gateway applies role-based and partner-based access control and logs calls, data access, and agent usage.

In Example 3, the subject matter of Examples 1-2 includes, wherein the system preserves data residency by performing prediction-time access to enterprise systems in situ.

In Example 4, the subject matter of Examples 1-3 includes, wherein the Prediction Events are not co-mingled with facts in default queries and are versioned via a schema version field.

In Example 5, the subject matter of Examples 1-4 includes, wherein the financial guardrail layer integrates treasury data with operational intelligence to provide real-time cash modeling and programmable guardrails.

In Example 6, the subject matter of Examples 1-5 includes, wherein the agent orchestration engine composes tools including APIs, knowledge retrieval, and models with policy controls for latency, freshness, and rate limits.

In Example 7, the subject matter of Examples 1-6 includes, wherein the integration layer supports REST, GraphQL, WebSockets, gRPC, MQTT, and EDI to communicate with ERP, WMS, TMS, CRM, and IoT devices.

Example 8 is a computer-implemented method for closed-loop orchestration of hospital operations and supply-chains, comprising: receiving a request at a unified invocation interface to execute a specified agent; retrieving, via a governed gateway, enterprise data in situ and a model from a BYOM registry; executing the agent with policy controls to generate a prediction; emitting a Prediction Event including uncertainty, reason codes, and lineage; updating a digital-twin simulation and evaluating a candidate action under financial guardrails; and returning a recommendation comprising actions and a confidence measure to a client system.

In Example 9, the subject matter of Example 8 includes, writing observability traces across an agent run and generating SLO metrics for latency and error rates.

In Example 10, the subject matter of Examples 8-9 includes, wherein explainability metadata is posted to an external explainability service and a link stored in the Prediction Event.

Example 11 is a non-transitory computer-readable medium storing instructions that, when executed by one or more processors, cause the processors to perform the steps of any of Examples 8-10.

In Example 12, the subject matter of Examples 8-11 includes, wherein the agent template specifies context identifiers, feature fields, exogenous signals, policies with max_latency_ms and freshness_sec, and output toggles for reason codes, uncertainty, and lineage.

In Example 13, the subject matter of Examples 1-12 includes, wherein the unified response includes a recommendation_id, actions list, confidence_score, and latency_ms.

In Example 14, the subject matter of Examples 1-13 includes, wherein the knowledge layer uses vector indices to support retrieval-augmented generation.

In Example 15, the subject matter of Examples 1-14 includes, and SLO burn alerts.

In Example 16, the subject matter of Examples 1-15 includes, and monitors API performance via Prometheus or OpenTelemetry.

In Example 17, the subject matter of Examples 1-16 includes, wherein CTD performs scenario planning that links visibility to simulation to action.

In Example 18, the subject matter of Examples 8-17 includes, wherein an explainability webhook provides post-hoc explanations with redaction of sensitive fields.

In Example 19, the subject matter of Examples 1-18 includes, wherein the platform provides human-in-the-loop approvals for selected action classes.

In Example 20, the subject matter of Examples 1-19 includes, wherein Decision Routing routes predictive insights and workflows across stakeholders in a role-aware manner.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

In various example examples, one or more portions of the network 110 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 110 or a portion of the network 110 may include a wireless or cellular network, and a coupling may be a Code Division Multiple Access (CDMA) connection, a Global System for Mobile communications (GSM) connection, or another type of cellular or wireless coupling. In this example, a coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology. Although an example has been described with reference to specific examples, it will be evident that various modifications and changes may be made to these examples without departing from the broader spirit and scope of the invention. Accordingly, the specification and drawings are to be regarded in an illustrative rather than a restrictive sense. The accompanying drawings that form a part hereof, show by way of illustration, and not of limitation, specific examples in which the subject matter may be practiced. The examples illustrated are described in sufficient detail to enable those skilled in the art to practice the teachings disclosed herein. Other examples may be utilized and derived therefrom, such that structural and logical substitutions and changes may be made without departing from the scope of this disclosure. This Detailed Description, therefore, is not to be taken in a limiting sense, and the scope of various examples is defined only by the appended claims, along with the full range of equivalents to which such claims are entitled.

Such examples of the inventive subject matter may be referred to herein, individually and/or collectively, by the term “invention” merely for convenience and without intending to voluntarily limit the scope of this application to any single invention or inventive concept if more than one is in fact disclosed. Thus, although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 816 and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium”discussed below.

The instructions may be transmitted or received over the network using a transmission medium via a network interface device (e.g., a network interface component included in the communication components) and utilizing any one of a number of well-known transfer protocols (e.g., hypertext transfer protocol (HTTP)). Similarly, the instructions may be transmitted or received using a transmission medium via the coupling (e.g., a peer-to-peer coupling) to the devices 770. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions for execution by the machine, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” “device-readable medium,” and “machine storage medium,” mean the same thing and may be used interchangeably in this disclosure. The terms are defined to include both machine-storage media and transmission media. Thus, the terms include both storage devices/media and carrier waves/modulated data signals. For instance, an embodiment described herein can be implemented using a non-transitory medium (e.g., a non-transitory computer-readable medium).

Throughout this specification, plural instances may implement resources, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

As used herein, the term “or” may be construed in either an inclusive or exclusive sense. The terms “a” or “an” should be read as meaning “at least one,” “one or more,” or the like. The presence of broadening words and phrases such as “one or more,” “at least,” “but not limited to,” or other like phrases in some instances shall not be read to mean that the narrower case is intended or required in instances where such broadening phrases may be absent. Additionally, boundaries between various resources, operations, components, engines, and data stores are somewhat arbitrary, and particular operations are illustrated in a context of specific illustrative configurations. Other allocations of functionality are envisioned and may fall within a scope of various embodiments of the present disclosure. The specification and drawings are, accordingly, to be regarded in an illustrative rather than a restrictive sense. It will be understood that changes and modifications may be made to the disclosed embodiments without departing from the scope of the present disclosure. These and other changes or modifications are intended to be included within the scope of the present disclosure.

What is claimed is:

1. A management system comprising:
a digital twin layer;
a data integration layer;
an artificial intelligence (AI) and cognitive processing layer;
data integration layer;
an extensibility and customization layer;
processing circuitry operatively coupled with the digital twin layer, the data integration layer, the AI and cognitive processing layer, the data integration layer, and the extensibility and customization layer; and
a memory device including instructions stored thereon, wherein the instructions, which when executed by the processing circuitry, configure the processing circuitry to perform operations that:
generates, with the digital twin layer, a virtual representation of a network that includes a hub and endpoints associated with the hub via electronic connections;
simulates, with the digital twin layer, an impact of an external factor on the hub, the endpoints, and the electronic connections;
uses the data integration layer to:
collect real-time data from multiple sources;
process the real-time data; and
continuously update the simulated impact with the digital twin layer using the real-time data;
applies, using the AI and cognitive processing layer, machine learning algorithms to the real-time data and simulated impact to generate predictive models;
enables, with the extensibility and customization layer, users to adjust parameters of the virtual representation to test alternative supply chain configurations;
evaluates, with the AI and cognitive processing layer, impacts of the alternative configurations on supply chain performance metrics; and
provides, with the AI and cognitive processing layer, optimization recommendations based on the evaluation such that bulk data movement is avoided.

2. The management system of claim 1, wherein the processing circuitry is further configured to perform operations that generate, using the AI and cognitive processing layer, recommendations for optimizing the network based on the real-time data and the simulated impact.

3. The management system of claim 1, wherein the network is a supply chain network and the end points include at least one of suppliers and distribution centers.

4. The management system of claim 3, wherein the management system further comprises a natural language interaction interface operatively coupled with the processing circuitry and the processing circuitry is further configured to perform operations that:
receives user queries in natural language format regarding supply chain operations associated with the supply chain;
processes the natural language queries using a large language model to identify relevant data and analysis requirements, and
generates responses to the user queries based on relevant data from the digital twin layer and artificial intelligence analysis engine.

5. The management system of claim 3, wherein the electronic connections represent transportation routes between the end points and between the end points and the hub.

6. The management system of claim 5, wherein the processing circuitry is further configured to perform operations that identify, with the AI and cognitive processing layer, potential disruptions to supply chain operations associated with the supply chain network.

7. The management system of claim 1, wherein the external impact is one of weather conditions at a location associated with one of the hub, the endpoints, and the electronic connections, traffic patterns at the location associated with one of the hub, the endpoints, and the electronic connections, and geopolitical events at the location associated with one of the hub, the endpoints, and the electronic connections.

8. The management system of claim 1, wherein the multiple sources includes Internet of Things (IoT) sensors, enterprise resource planning (ERP) systems, warehouse management systems (WMS), and transportation management systems (TMS).

9. A method of operating a management system comprising a digital twin layer, a data integration layer, an artificial intelligence (AI) and cognitive processing layer, data integration layer, and an extensibility and customization layer, the method comprising:
generating, with the digital twin layer, a virtual representation of a network that includes a hub and endpoints associated with the hub via electronic connections;
simulating, with the digital twin layer, an impact of an external factor on the hub, the endpoints, and the electronic connections;
using the data integration layer to:
collect real-time data from multiple sources;
process the real-time data; and
continuously update the simulated impact with the digital twin layer using the real-time data;
applying, using the AI and cognitive processing layer, machine learning algorithms to the real-time data and simulated impact to generate predictive models;
enabling, with the extensibility and customization layer, users to adjust parameters of the virtual representation to test alternative supply chain configurations;
evaluating, with the AI and cognitive processing layer, impacts of the alternative configurations on supply chain performance metrics; and
providing, with the AI and cognitive processing layer, optimization recommendations based on the evaluation such that bulk data movement is avoided.

10. The method of claim 9, that the method further comprising generating, using the AI and cognitive processing layer, recommendations for optimizing the network based on the real-time data and the simulated impact.

11. The method of claim 9, wherein the network is a supply chain network and the end points include at least one of suppliers and distribution centers.

12. The method of claim 11, wherein the management system further comprises a natural language interaction interface and the method further comprises:
receiving user queries in natural language format regarding supply chain operations associated with the supply chain;
processing the natural language queries using a large language model to identify relevant data and analysis requirements, and
generating responses to the user queries based on relevant data from the digital twin layer and artificial intelligence analysis engine.

13. The method of claim 11, wherein the electronic connections represent transportation routes between the end points and between the end points and the hub.

14. The method of claim 13, wherein the method further comprises identifying, with the AI and cognitive processing layer, potential disruptions to supply chain operations associated with the supply chain network.

15. The method of claim 9, wherein the external impact is one of weather conditions at a location associated with one of the hub, the endpoints, and the electronic connections, traffic patterns at the location associated with one of the hub, the endpoints, and the electronic connections, and geopolitical events at the location associated with one of the hub, the endpoints, and the electronic connections.

16. The method of claim 9, wherein the multiple sources includes Internet of Things (IoT) sensors, enterprise resource planning (ERP) systems, warehouse management systems (WMS), and transportation management systems (TMS).

17. A non-transitory, machine-readable medium, comprising instructions, which when performed by a processor of a management system comprising a digital twin layer, a data integration layer, an artificial intelligence (AI) and cognitive processing layer, data integration layer, and an extensibility and customization layer, causes the processor to perform operations to:
generate, with the digital twin layer, a virtual representation of a network that includes a hub and endpoints associated with the hub via electronic connections;
simulate, with the digital twin layer, an impact of an external factor on the hub, the endpoints, and the electronic connections;
use the data integration layer to:
collect real-time data from multiple sources;
process the real-time data; and
continuously update the simulated impact with the digital twin layer using the real-time data;
apply, using the AI and cognitive processing layer, machine learning algorithms to the real-time data and simulated impact to generate predictive models;
enable, with the extensibility and customization layer, users to adjust parameters of the virtual representation to test alternative supply chain configurations;
evaluate, with the AI and cognitive processing layer, impacts of the alternative configurations on supply chain performance metrics; and
provide, with the AI and cognitive processing layer, optimization recommendations based on the evaluation such that bulk data movement is avoided.

18. The non-transitory, machine-readable medium of claim 17, wherein the instructions further configure the processor to perform operations that generate, using the AI and cognitive processing layer, recommendations for optimizing the network based on the real-time data and the simulated impact.

19. The non-transitory, machine-readable medium of claim 17, wherein:
the network is a supply chain network and the endpoints include at least one of suppliers and distribution centers; and
the management system further comprises a natural language interaction interface and the instructions further configure the processor to perform operations that:
receives user queries in natural language format regarding supply chain operations associated with the supply chain;
processes the natural language queries using a large language model to identify relevant data and analysis requirements, and
generates responses to the user queries based on relevant data from the digital twin layer and artificial intelligence analysis engine.

20. The non-transitory, machine-readable medium of claim 17, wherein the electronic connections represent transportation routes between the end points and between the end points and the hub and the instructions further configure the processor to perform operations that identify, with the AI and cognitive processing layer, potential disruptions to supply chain operations associated with the supply chain network.
